(19) United States
(12) Patent Application Publication
(10) Pub. No.: US 2013/0059284 A1
(43) Pub. Date: Mar. 7, 2013

(54) INTERACTIVE ELECTRONIC TOY AND LEARNING DEVICE SYSTEM

(71) Applicants: Thomas H. Giedgowd, JR., Glen Allen, VA (US); Kevin Owen, Crozet, VA (US); Thomas Williams, III, Leesburg, VA (US); Weston Edwards, Charlottesville, VA (US)

(72) Inventors: Thomas H. Giedgowd, JR., Glen Allen, VA (US); Kevin Owen, Crozet, VA (US); Thomas Williams, III, Leesburg, VA (US); Weston Edwards, Charlottesville, VA (US)

(73) Assignee: TEEGEE, LLC, Glen Allen, VA (US)

(21) Appl. No.: 13/605,519

(22) Filed: Sep. 6, 2012

Related U.S. Application Data
(60) Provisional application No. 61/531,673, filed on Sep. 7, 2011.

(51) Int. Cl. G09B 25/00; G06F 15/16

(52) U.S. Cl. 434/365; 709/219

(57) ABSTRACT

A device and system of information exchange for an educational toy is disclosed. Inside an external shell is placed a small computer. The Device interacts through auditory and visual responses, and accepts input through buttons, RFID accessories, smart cards and speech. The Device communicates with other like devices through a wireless Bluetooth connection. The Device receives information updates via a Bluetooth dongle that plugs into the end user's computer. When the Device is synchronized with the end user's computer, new information is pushed to (and stored in) the Device's internal computer. The end user's computer automatically downloads updates and configuration information from a central web server, via a background software application, which can be transferred during synchronization. Updates and configuration information are available via an online store hosted on the central server. The Device leverages the end user's smartphone to partially replace functionality performed by the internal computer.

### RELATED APPLICATIONS

This application claims priority to U.S. Provisional Patent Application No. 61/531,673 filed Sep. 7, 2011 by the same inventors and bearing the title “Interactive Electronic Toy/Learning Device System Capable of Wireless Updates, Configuration through a Website, Environment Interaction through Smart Accessories/Cards, Speech Recognition, and Wireless Device-To-Device Communication.” U.S. Provisional Patent Application No. 61/531,673 is hereby incorporated by reference as if repeated herein in its entirety, including the drawings.

### BACKGROUND

The majority of toys and educational devices have static content, meaning that whatever content was loaded onto the device at manufacture time is the same content that will remain on the device for the lifetime of the device. Other toys and devices that allow their content to be upgraded typically require expansion packs, cables, or cartridges that must be physically attached to the device in order to transfer information.

The majority of toys and educational devices claiming to be “interactive” also provide a superficial level of interaction with their users, typically recycling the same content over and over again and requiring physical button presses to interact with the device.

The present invention is therefore directed to the problem of developing an interactive toy or learning device that can easily be updated while providing a sophisticated level of interaction.

### SUMMARY OF THE INVENTION

The present invention solves these and other problems by providing a new way of on-the-fly content updating for toys and educational devices that can be pulled from a central web server. This allows parents to completely customize how the toy/educational device behaves depending on the age, needs and preferences of their child.

Moreover, the present invention proposes a combination of several ways on interacting with the device, including but not limited to: button presses, smart accessories, smart cards, speech command recognition, and device-to-device communication. Offering this combination of input methods serves to make the play experience between the child and the toy/educational device much more engaging.

According to one aspect of the present invention, an exemplary embodiment of an interactive entertainment apparatus includes an exterior shell and a non-transitory computer readable media that can be loaded into an end user's computer. The exterior shell has a humanoid or animal shape with one or more extremities. Any animal, toy or human shape may suffice. The shell houses an internal computer and one or more tactile control buttons. The internal computer includes a central processing unit, memory coupled to the central processing unit and a rechargeable battery to power the internal computer. The internal computer also includes a wireless connectivity adapter coupled to the central processing unit to provide wireless connectivity to other wireless devices when brought in a predetermined proximity of the shell. The internal computer also includes an RFID tag reader to read an RFID tag when brought in vicinity of the shell and a wireless network adapter. The internal computer includes an internal database to store information regarding multiple smart cards and smart accessories. The internal computer executes a predetermined application associated with an identified RFID tag to change a behavior of the shell upon detection and identification of a new RFID tag. The internal computer determines when a given RFID tag entered proximity of the shell and when the given RFID tag left proximity of the shell to determine how long the RFID tag remained in proximity of the shell. Each of the smart accessories has associated with it a unique smart accessory RFID tag. Each of the smart cards has associated with it a unique smart card RFID tag. The internal database stores smart card applications in association with the smart cards, one smart card application for each smart card. The internal database also stores smart accessory applications in association with the smart accessories, one smart accessory application for each smart accessory. Each smart accessory application controls a behavior of the shell in response to the shell being brought in proximity to an associated smart accessory. Each smart card application controls a behavior of the shell in response to the shell being brought in proximity to an associated smart card. The tactile control buttons are coupled to the internal computer, and can be activated by pressing. The user may select one or more applications to execute on the internal computer by pressing one of the tactile control buttons and cycling through the applications each time the tactile control buttons is pressed, and then holding the tactile control button for a predetermined time to select the desired applications. The non-transitory computer readable media has stored thereon an end user application, which when executing enables an end user computer to perform a synchronization process with the internal computer and to obtain configuration updates and new applications from a central web server. The internal computer communicates with an end user computer via the wireless connectivity adapter to obtain configuration updates and new applications during a synchronization process with the end user computer.

In the above exemplary embodiment, the internal computer may include an audio speaker to output audio signals from the central processing unit.

In the above exemplary embodiment, the internal computer may also include an audio microphone to pick up audio signals and provide these audio signals to the central processing unit.

In the above exemplary embodiment, the internal computer may also include speech recognition capability to respond to voice commands issued by a user. The internal computer executes a predetermined application based on a recognized voice command.

According to another aspect of the present invention, an exemplary embodiment of an updatable, interactive entertainment apparatus includes an exterior shell having a humanoid or animal shape. The shape includes one or more extremities. The shell has a data/power cord to couple to a portable computing device, such as a smart phone, smart device, portable computer, laptop computer or the like. The apparatus also includes a tactile control button to couple to the portable computing device via the data/power cord. The tactile control button is activated by pressing on the button. The user may select an application to execute on the portable computing device by pressing the tactile control button and cycling through several applications each time the tactile control button is pressed, and then holding the tactile control button for a predetermined time to select the desired application. The apparatus also includes a non-transitory computer readable media having stored thereon an application for execution on the portable computing device. The application enables the portable computing device to provide wireless connectivity to other wireless devices when brought in a predetermined proximity of the shell. The application also enables the smart phone to include a RFID tag reader to read an RFID tag when brought in vicinity of the shell. The application also enables the portable computing device to execute a predetermined application associated with an identified RFID tag to change a behavior of the shell upon detection and identification of a new RFID tag. The application also enables the portable computing device to determine when a given RFID tag entered proximity of the shell and when the given RFID tag left proximity of the shell to determine how long the RFID tag remained in proximity of the shell. The application also enables the portable computing device to determine how long a given RFID tag has remained in proximity of the shell for use in controlling the behavior of the shell. The application also enables the portable computing device to store an internal database of information regarding several smart cards and several smart accessories. Each smart accessory has associated with it a unique smart accessory RFID tag. Each smart card has associated with it a unique smart card RFID tag. The internal database stores smart card applications in association with smart cards, one smart card application for each smart card. The internal database stores smart accessory applications in association with smart accessories, one smart accessory application for each smart accessory. Each smart accessory application controls behavior of the shell in response to the shell being brought in proximity to an associated smart accessory. Each smart card application controls behavior of the shell in response to the shell being brought in proximity to an associated smart card. The application also enables an end user computer to perform a synchronization process with the portable computing device and to obtain configuration updates and new applications from a central web server. The application also enables the portable computing device to communicate with a central web server.

In the above exemplary embodiment, the application may also enable the portable computing device to recognize one or more voice commands issued by a user. The application enables the portable computing device to execute a predetermined application based on a recognized voice command to cause the shell to behave in a way responsive to the voice command.

According to yet another aspect of the present invention, an exemplary embodiment of a non-transitory computer readable media has stored thereon an application for execution on a portable computer to control an entertainment device. When executing the application causes the portable computer to provide wireless connectivity to other wireless devices when brought in a predetermined proximity of the entertainment device. The application also causes the portable computer to provide an RFID tag reader to read an RFID tag when brought in vicinity of the shell. The application also causes the portable computer to execute a predetermined application associated with an identified RFID tag to change a behavior of the shell upon detection and identification of a new RFID tag. The application also causes the portable computer to determine when a given RFID tag entered proximity of the shell and when the given RFID tag left proximity of the shell to determine how long the RFID tag remained in proximity of the shell. The application also enables the portable computer to determine how long a given RFID tag has remained in proximity of the shell for use in controlling behavior of the shell.

The application causes the portable computer to store an internal database of information regarding smart cards and smart accessories. Each smart accessory has associated with it a unique smart accessory RFID tag. Each smart card has associated with it a unique smart card RFID tag. The internal database stores smart card applications in association with smart cards, one smart card application for each smart card. The internal database stores smart accessory applications in association with smart accessories, one smart accessory application for each smart accessory. Each smart accessory application controls behavior of the shell in response to the shell being brought in proximity to an associated smart accessory. Each smart card application controls behavior of the shell in response to the shell being brought in proximity to an associated smart card.

In the above exemplary embodiment, the application may enable the portable computer to obtain configuration updates and new applications for the entertainment device from a central web server.

In the above exemplary embodiment, the application may enable the portable computer to communicate with a central web server to obtain configuration information, updates or new applications for the entertainment device.

According to another aspect of the present invention, an exemplary embodiment of a method for enabling a learning device or toy to interact with an end user includes: disposing an internal computer inside an exterior shell of the learning device or toy; providing wireless connectivity to other wireless devices when brought in a predetermined proximity of the learning device or toy; reading a radio frequency identification tag when brought in a vicinity of the learning device or toy; and executing a predetermined application associated with an identified radio frequency identification tag to change behavior of the learning device or toy upon detection and identification of a new radio frequency identification tag.

In the above exemplary embodiment, the method may include determining how long a radio frequency identification tag remained in proximity of the learning device or toy, and controlling behavior of the learning device or toy based on a length of time the given radio frequency identification tag remained in proximity of the learning device or toy.

In the above exemplary embodiment, the method may include storing inside the learning device or toy an internal database of information regarding smart cards, associating with each smart card a unique smart card radio frequency identification tag, storing in the internal database smart card applications in association with smart cards, one smart card application for each smart card, and controlling behavior of the learning device or toy with each smart card application when the learning device or toy is brought in proximity of an associated smart card.

In the above exemplary embodiment, the method may include storing inside the learning device or toy an internal database of information regarding smart accessories, associating with each smart accessory a unique smart accessory radio frequency identification tag, storing in the internal database smart accessory applications in association with smart accessories, one smart accessory application for each smart accessory, and controlling behavior of the learning device or toy with each smart accessory application when the learning device or toy is brought in proximity of an associated smart accessory.

In the above exemplary embodiment, the method may include providing tactile control buttons coupled to the internal computer, enabling a user to select applications to execute on the internal computer by pressing the tactile control buttons and cycling through the applications each time the tactile control button is pressed, and then holding the tactile control button for a predetermined time to select the desired application.

In the above exemplary embodiment, the method may include synchronizing the internal computer in the learning device or toy with an end user computer to obtain configuration updates and new applications from a central web server via the end user computer.

In the above exemplary embodiment, the method may include receiving audio signals and providing the received audio signals to the internal computer.

In the above exemplary embodiment, the method may include responding to one or more voice commands issued by a user by executing a predetermined application on the internal computer based on a recognized one of a plurality of voice commands.

### BRIEF DESCRIPTION OF THE DRAWINGS

FIG. 1 depicts an exemplary embodiment of an interactive toy according to one aspect of the present invention.

FIG. 2 depicts an exemplary embodiment of an updateable, interactive toy or learning device system according to another aspect of the present invention.

FIG. 3 depicts an exemplary embodiment of an updateable, interactive toy or learning device system for interacting with smart accessories, according to yet another aspect of the present invention.

FIG. 4 depicts an exemplary embodiment of an updateable, interactive toy or learning device system that interacts with a Radio Frequency Identification (RFID) tag according to still another aspect of the present invention.

FIG. 5 depicts a block diagram of an end user's computer interacting with an online store to obtain updates and other configuration information for an exemplary embodiment of an interactive toy or learning device system according to yet another aspect of the present invention.

FIG. 6 depicts an exemplary embodiment of method for interacting with an interactive toy or learning device system according to yet another aspect of the present invention.

FIG. 7 depicts an exemplary embodiment of method for communicating with an interactive toy or learning device system according to still another aspect of the present invention.

FIG. 8 depicts an exemplary embodiment of control buttons for an interactive toy or learning device system according to still another aspect of the present invention.

FIG. 9 depicts an exemplary embodiment of smart card for use with an interactive toy or learning device system according to still another aspect of the present invention.

FIG. 10 depicts another exemplary embodiment of an interactive toy or learning device system according to yet another aspect of the present invention.

FIG. 11 depicts an exemplary embodiment of the components within an interactive toy or learning device system according to yet another aspect of the present invention.

FIG. 12 depicts exemplary embodiment of an apparatus for communicating with an interactive toy or learning device system according to yet another aspect of the present invention.

FIG. 13 depicts a schematic diagram of an exemplary embodiment of an internal computer for use in an interactive toy or learning device system according to yet another aspect of the present invention.

FIG. 14 depicts two photographs of the front and back sides of an exemplary embodiment of an internal computer for use in an interactive toy or learning device system according to yet another aspect of the present invention.

FIGS. 15-19 depict schematic diagrams of exemplary embodiments of an internal computer for use in an interactive toy or learning device system according to yet another aspect of the present invention.

### DETAILED DESCRIPTION

Disclosed herein is an interactive electronic toy/learning device system capable of wireless updates, configuration through a website, environment interaction through smart accessories/cards, response based on speech recognition commands, and wireless device-to-device communication, charging and configuration.

### Overview

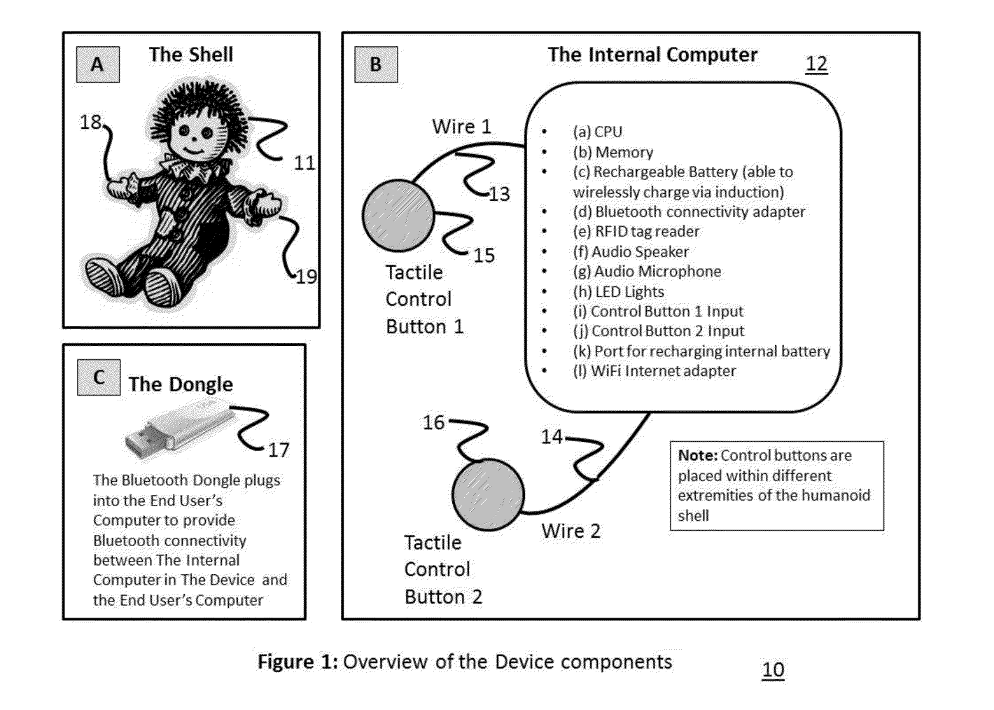

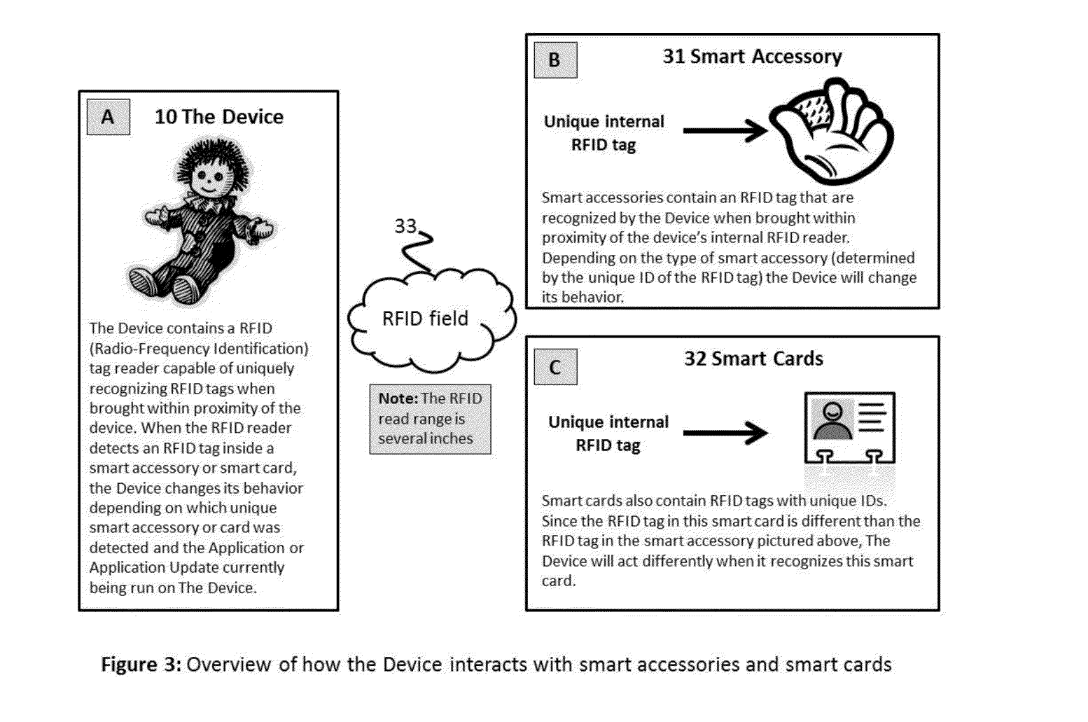

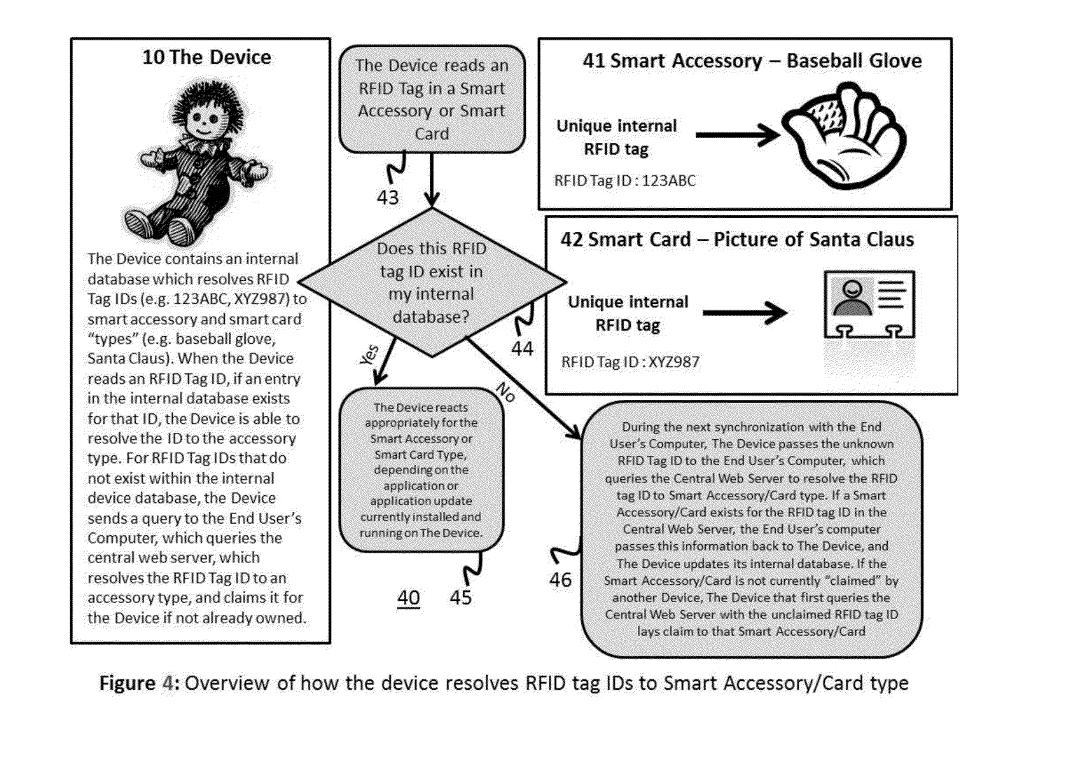

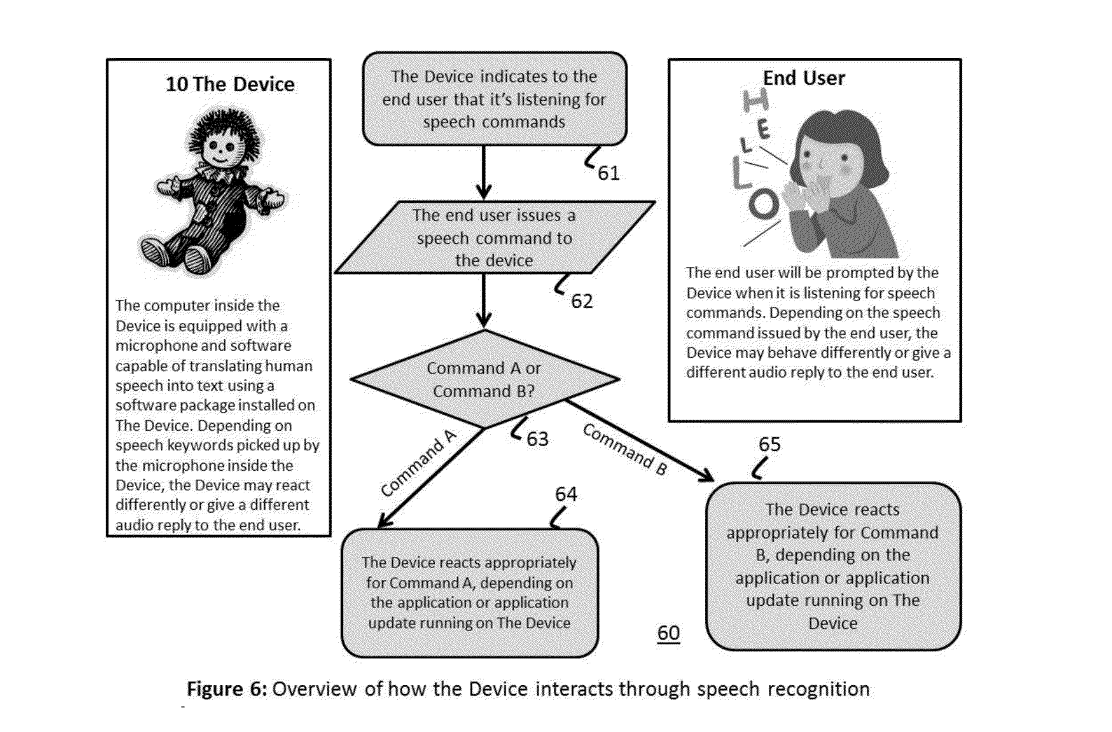

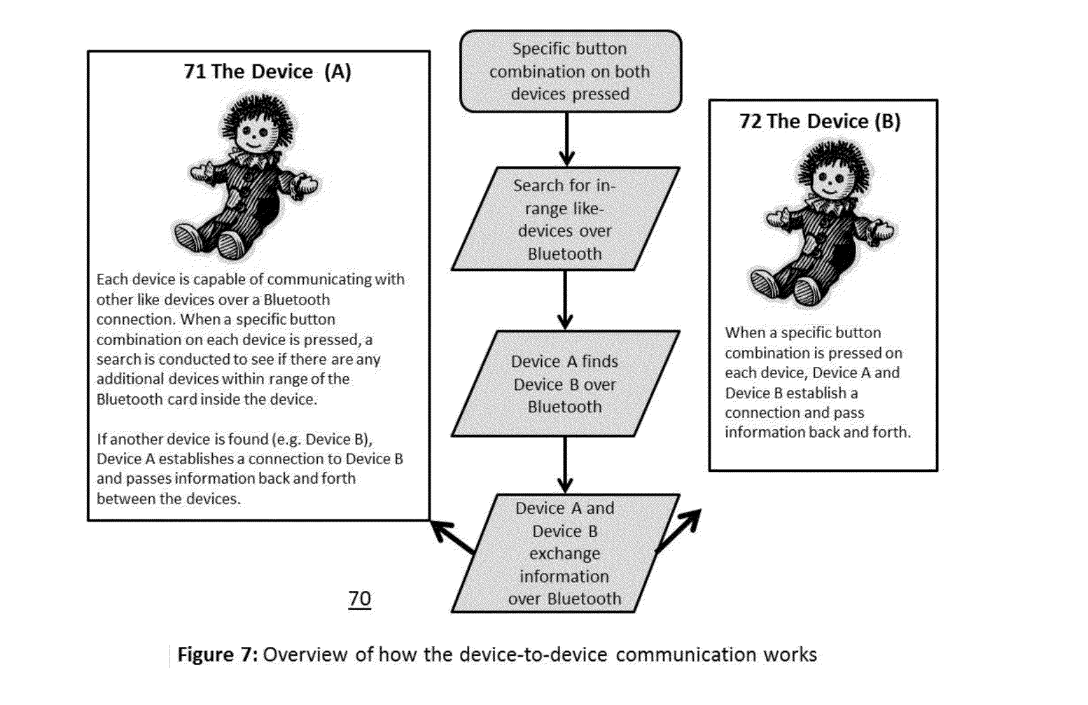

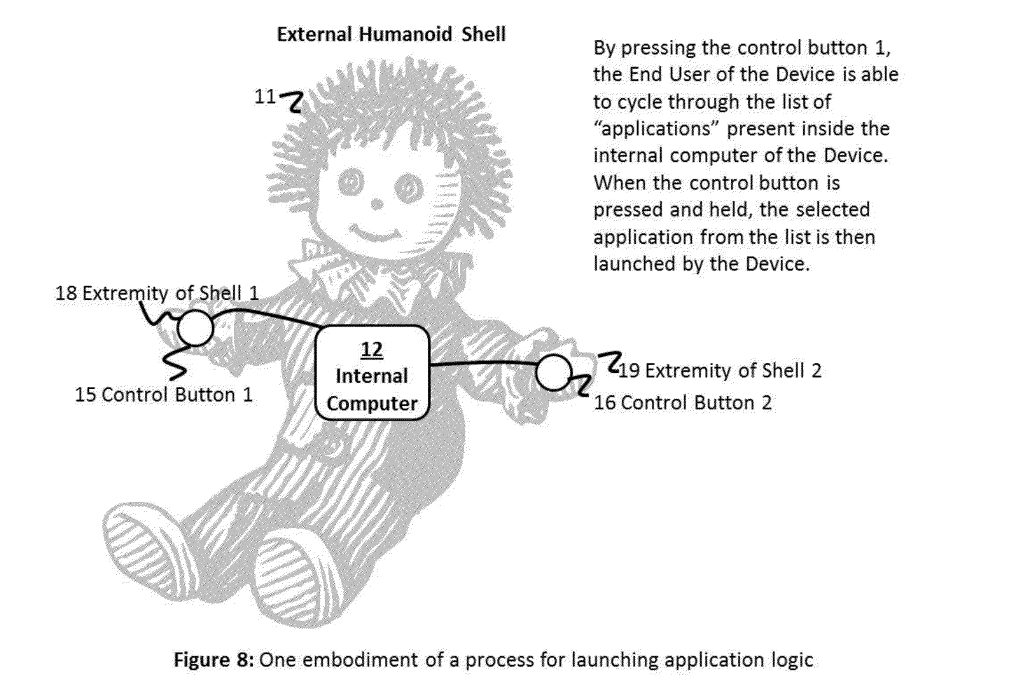

The present invention includes an electronic device and associated system of information exchange for use in an educational or recreational toy. The electronic device (“the Device”) consists of a miniature custom computer 12 (“the internal computer”) (see FIG. 1) placed inside of an external humanoid shell 11 resembling a children's doll, stuffed animal or the like (“the Shell”). The Device 10 is capable of interacting with end users through auditory and visual responses (see FIG. 6), and accepts input through activating buttons (e.g., buttons that may be pressed to activate them) on the device (see FIG. 8), RFID (Radio-Frequency Identification) accessories and cards (“smart accessories” and “smart cards”) (see FIGS. 3-4), and speech commands given to the Device from the end user (see FIG. 6). The Device is also able to communicate with other like devices through a wireless Bluetooth connection and established information exchange protocol (see FIG. 7).

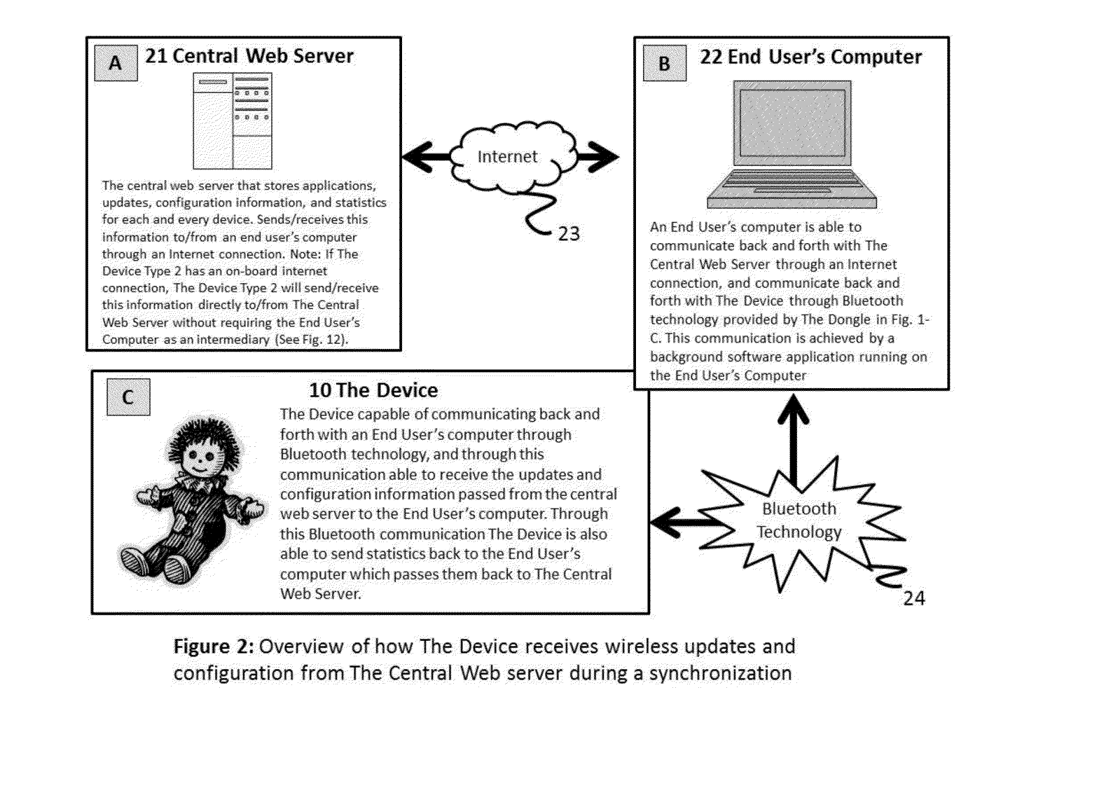

The Device is also capable of receiving wireless information updates (“updates” and “applications”) through a Bluetooth connection with the end user's computer (see FIG. 2). Included as part of the entire system is a Bluetooth dongle (“the dongle”) that plugs into the end user's computer and allows this connection to take place between the end user's computer and the Device (see FIG. 1). When the Device is synchronized with the end user's computer over the Bluetooth connection, new information is pushed to (and stored in) the internal computer within the Device. During this synchronization process, the Device also is capable of sending usage statistics back to the end user's computer, which can upload those statistics to the central web server (see FIG. 2).

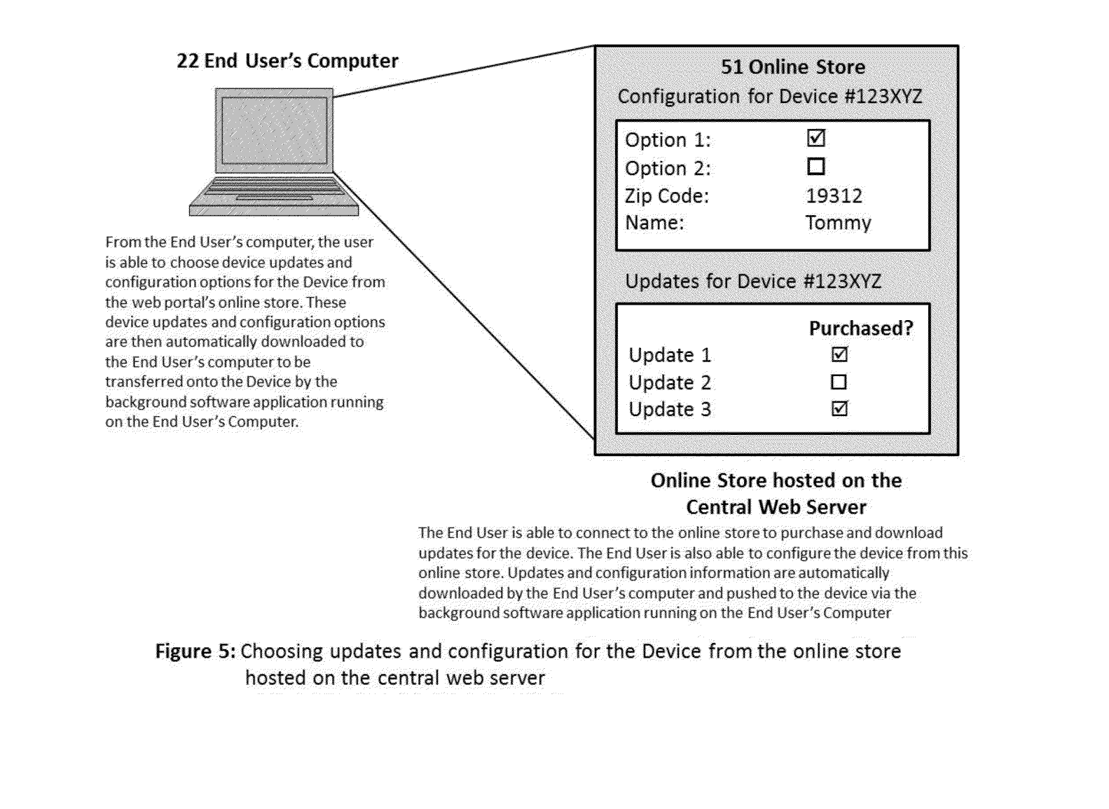

The end user's computer is able to automatically download device updates and configuration information from the central web server via a background software application running on the end user's computer. These updates and configuration information are then transferred to the Device during a synchronization event with the end user's computer (see FIG. 2). The end user is capable of choosing the updates and configuration information for the Device via an online store hosted on the central web server (see FIG. 5).

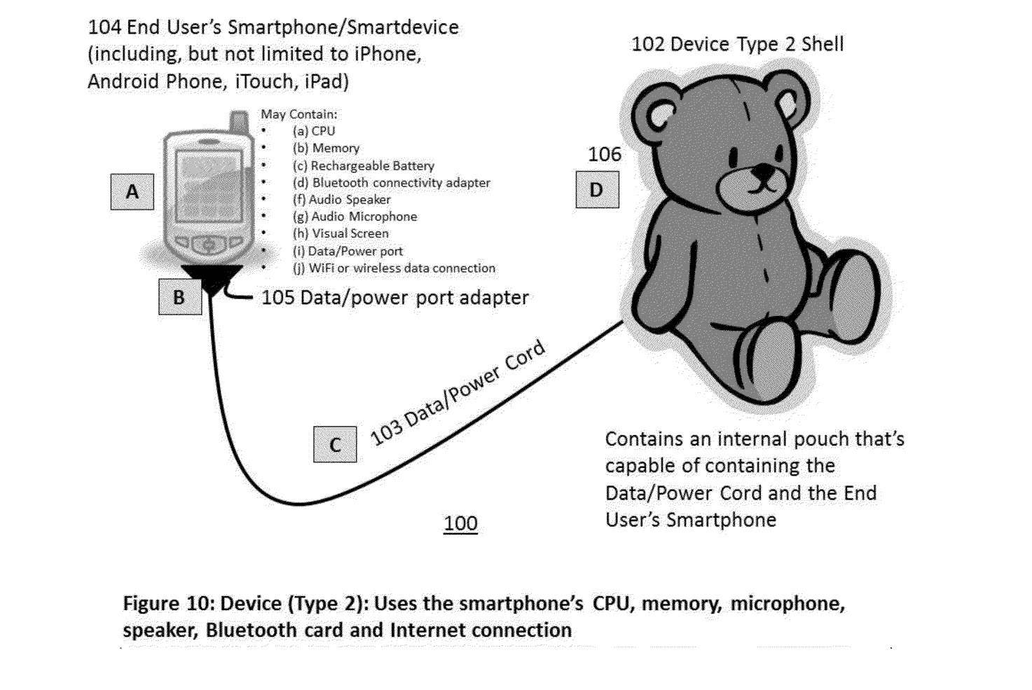

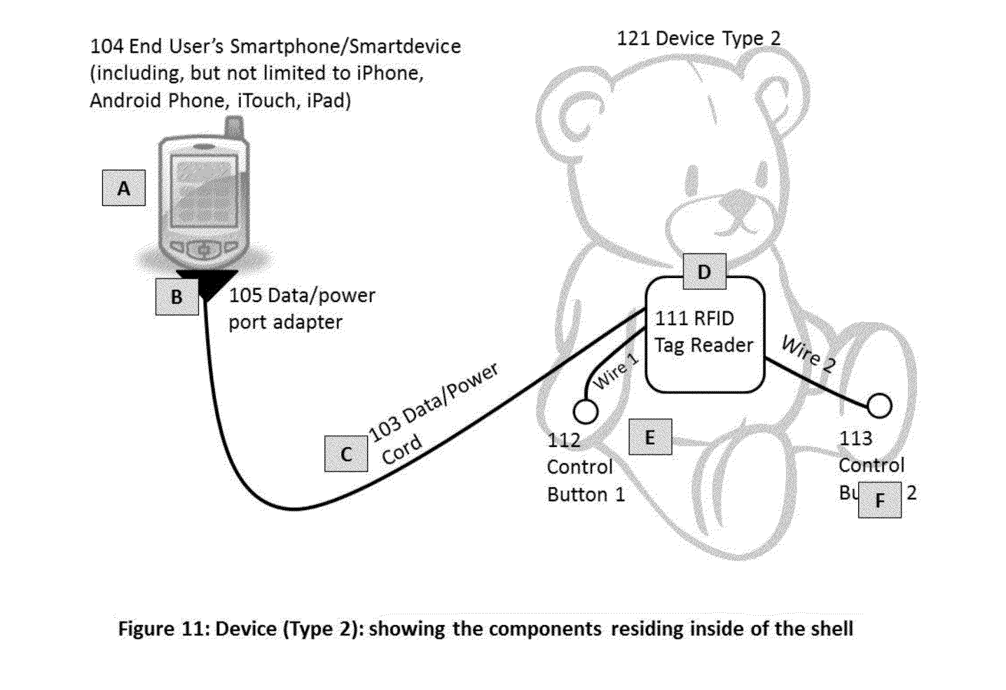

The present invention includes a second embodiment (the Device Type 2) which is capable of leveraging the end user's smartphone to partially replace the functionality performed by the internal computer in the Device (see FIGS. 10-11). In this second embodiment, the functionality of both the Device and the Device Type 2 are identical except where noted explicitly below.

The purpose of the interactive toy or learning device system described below is to provide a lifelike toy or educational device to a child that offers a robust and interactive educational play experience. The Device will be able to play games, tell stories, and educate a child through auditory communication, sounds and lighted responses, such as LED responses. Depending on the age, ability, and preferences of the child, parents will be able to load different applications and content onto the Device that are appropriate for their child. For example, if a parent wishes to teach their child Spanish, the parent would be able to load a Spanish language application on the Device, or if the parent wanted the device to sing nursery rhymes, the parent could load the device with nursery rhymes, all downloaded from a central web server and transferred onto the Device. The applications and application logic that runs on the device may also be pulled from an external party's central web server. In the Device Type 2 embodiment, the application logic transferred onto the end user's smartphone or smart device could come from the Apple App Store (if using an Apple iOS device) or an Android market (if using an Android device).

The different updates and applications loaded onto the toy are able to interact with children through a number of different inputs. One way of interacting with the Device is via two “control buttons” placed inside the extremities of the Device (e.g., one button is disposed inside a hand, and one button is disposed inside a foot or another hand, see FIG. 8). When a child presses either of these buttons, the Device is capable of behaving differently depending on what application logic is currently loaded and running on the Device.

As used herein, behavior can include outputting prerecorded voice messages, moving a limb or other body part, modifying the facial expression, and is only limited to the imagination of the creator. The behavior of the device comprises the set of interactions between the device and the end user. These interactions include the projection of audio from the device speaker (e.g., speech, sound effects and/or music), illumination of the LED lights from the device, and vibration (when using a smart device equipped with a vibration motor). For example, if a certain smart accessory is presented to the device (e.g., an Apple), the device may project an audio response of “Yummy”, play a sound effect of someone eating an apple, flash an LED light, and activate the vibration capability of the smartphone or handheld computer residing in the device (if applicable).

The Device is also able to accept and recognize speech commands from the end user, allowing the end user to change the Device's behavior when the end user issues certain “keyword” commands (see FIG. 6). Finally, the Device can also be equipped with an internal RFID tag reader (see FIG. 1). This RFID tag reader enables the device to interact with a library of smart accessories and smart cards when the accessory or card is brought within a close proximity of the device (see FIG. 3). A complete description of each system component can be found in the following sections.

### The Device

Turning to FIG. 1, shown therein is an exemplary embodiment of an interactive, updatable toy or learning device 10 (termed herein “the Device”). The Device 10 includes a shell 11, which forms the exterior of the Device 10, which shell 11 resembles a stock toy doll, stuffed animal or the like (e.g., any other toy or learning device). The Device 10 also includes one or more control buttons 15, 16 residing inside the shell 11. For example, in this embodiment of the Device 10, on two of the Device's extremities 18, 19 there may be external markings (not shown) indicating to the user that there are control buttons 15, 16 residing inside the extremity 11 that can be pressed to activate the interactivity of the Device.

### Internal Computer

Inside the body 11 of the Device 10 is a miniature computer 12 that may contain the following components: (a) CPU; (b) memory; (c) rechargeable battery that is able to charge via wireless induction, as well as a direct electrical connectivity; (d) Bluetooth connectivity adapter; (e) RFID tag reader; (f) audio speaker; (g) audio microphone; (h) LED lights; (i) control button 1 input; (j) control button 2 input; (k) a port for recharging the internal battery; and (l) a WiFi Internet adapter. Wires 13, 14 connect the two inputs for the control buttons with the actual tactile control buttons 15, 16 residing in two of the device's extremities 18, 19. Control buttons 15, 16 are typically placed within different extremities of the shell 11.

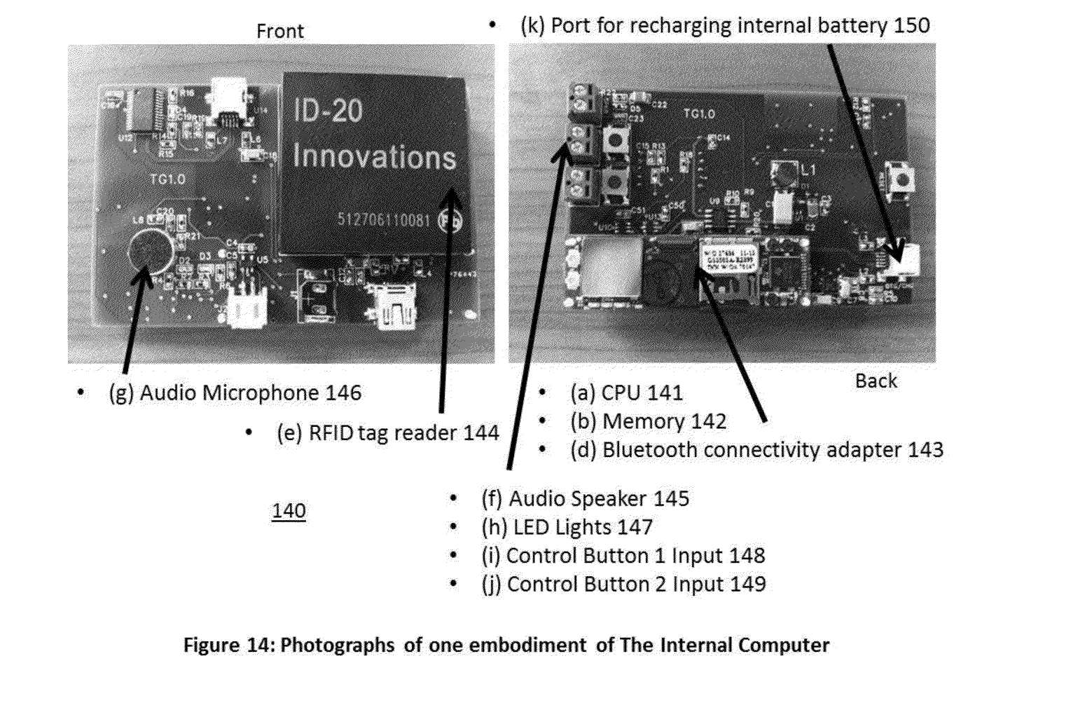

Turning to FIG. 14, shown therein are photographs of the front and back sides of one embodiment 140 of the internal computer 12. The internal computer includes: (a) a CPU 141; (b) memory 142; (d) a Bluetooth connectivity adapter 143; (e) an RFID reader 144; (f) an audio speaker 145; (g) an audio microphone 146; (h) LED lights 147; (i) control button 1 input 148; (j) control button 2 input 149; and (k) a port for recharging an internal battery 150.

Device 10 interacts with a Bluetooth dongle 17 (which is not necessarily part of the Device) that plugs into the end user's computer 22 (see FIG. 2) to provide Bluetooth connectivity between the internal computer 12 in the Device 10 and the end user's computer 22.

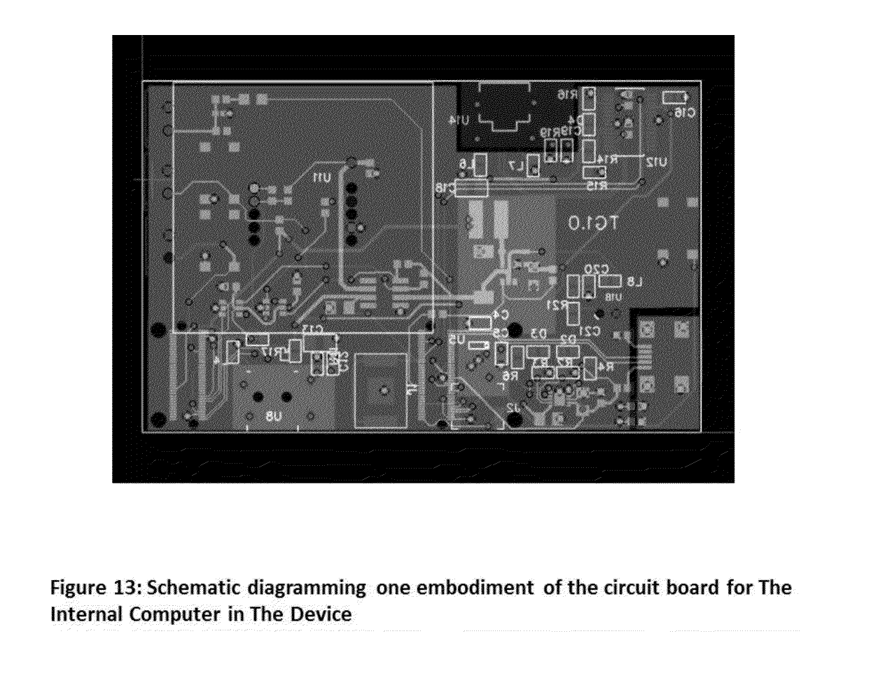

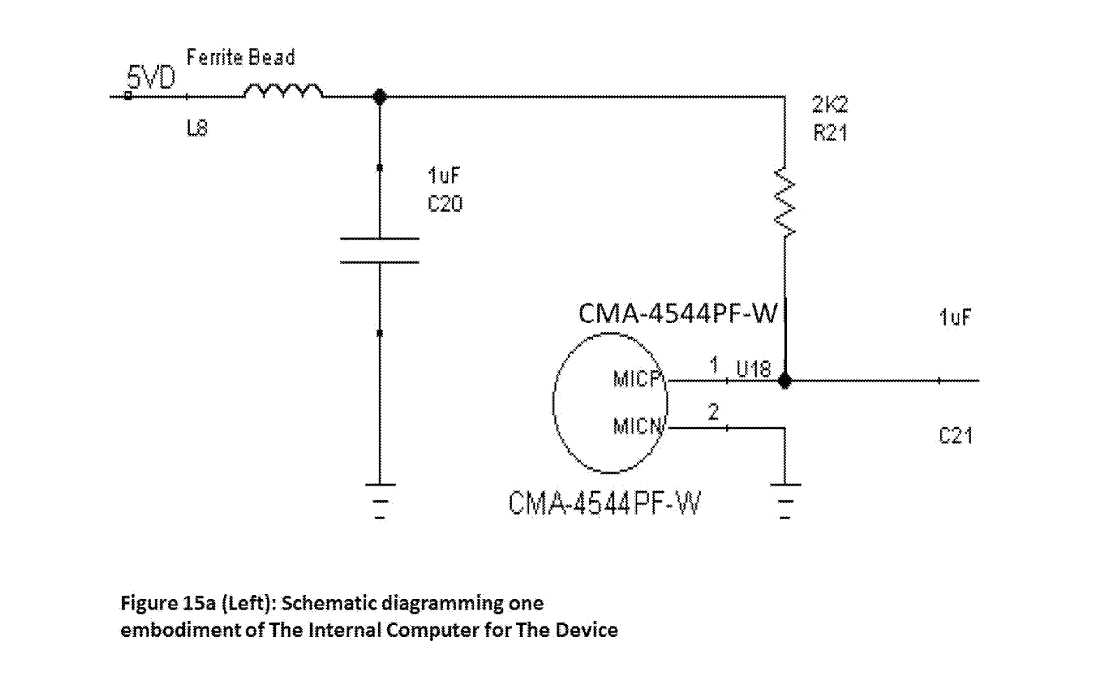

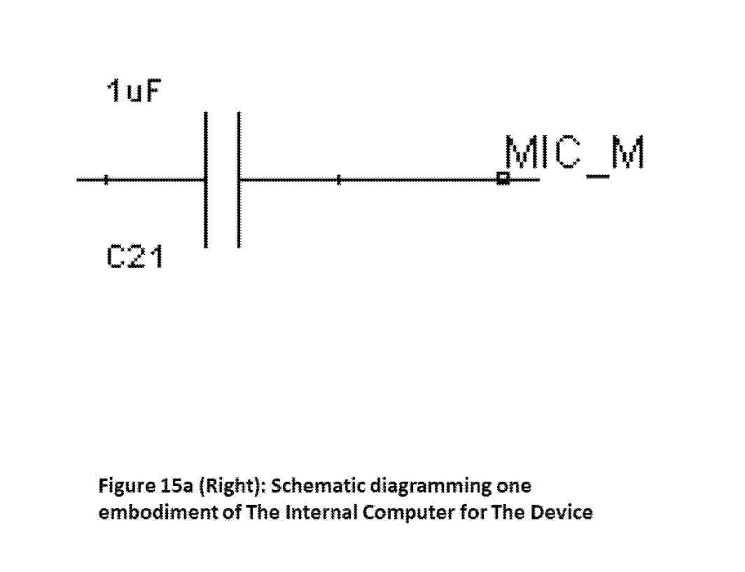

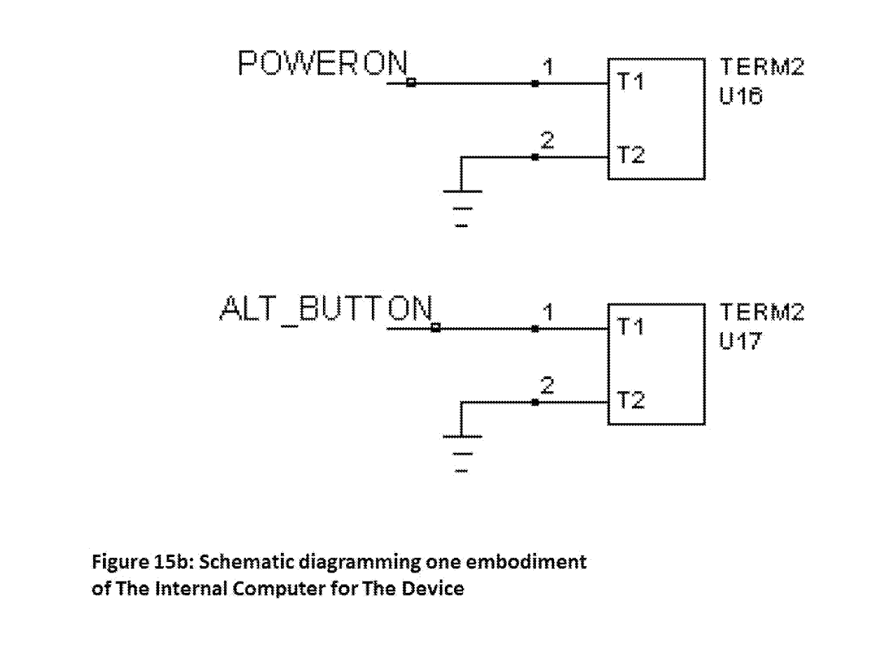

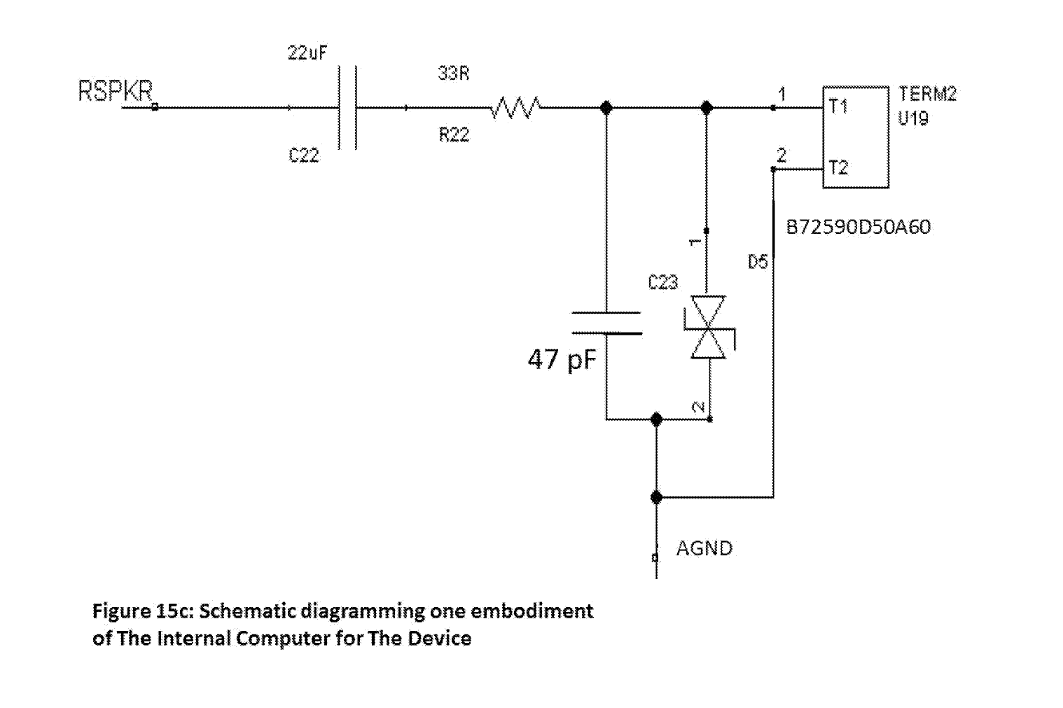

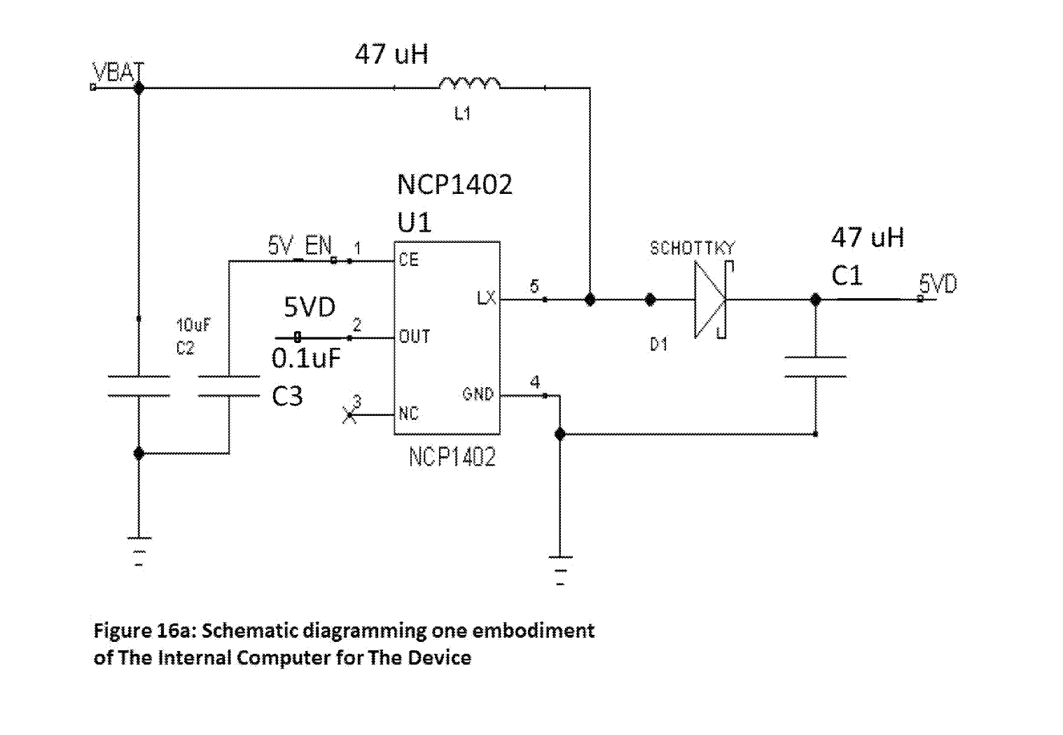

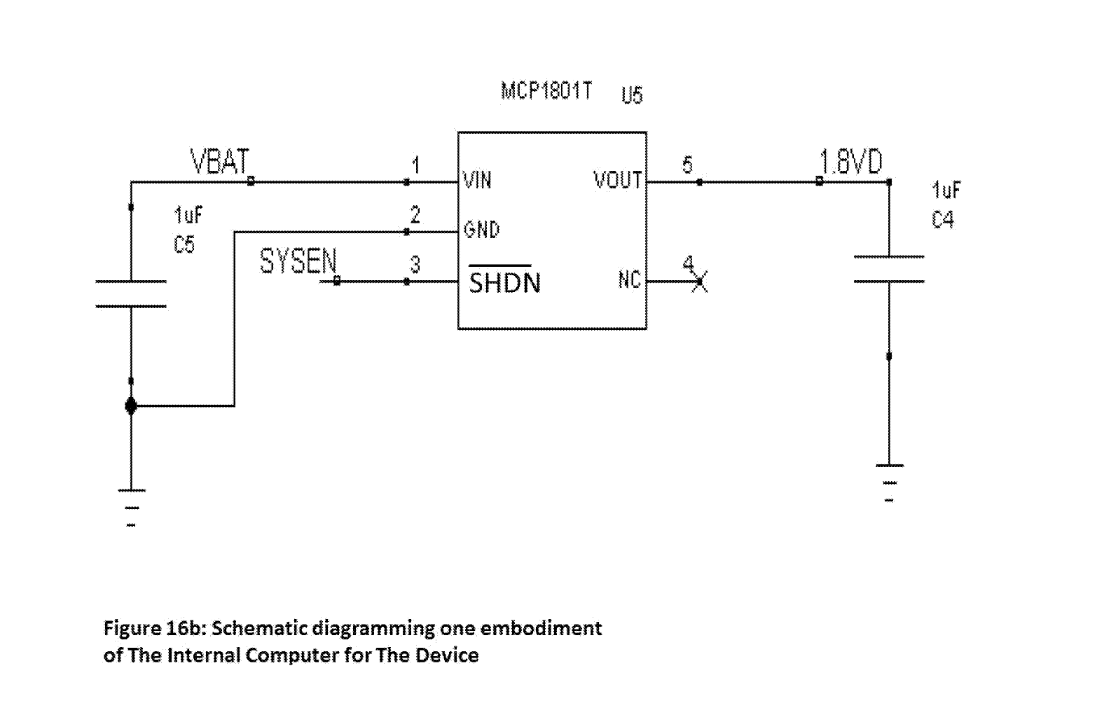

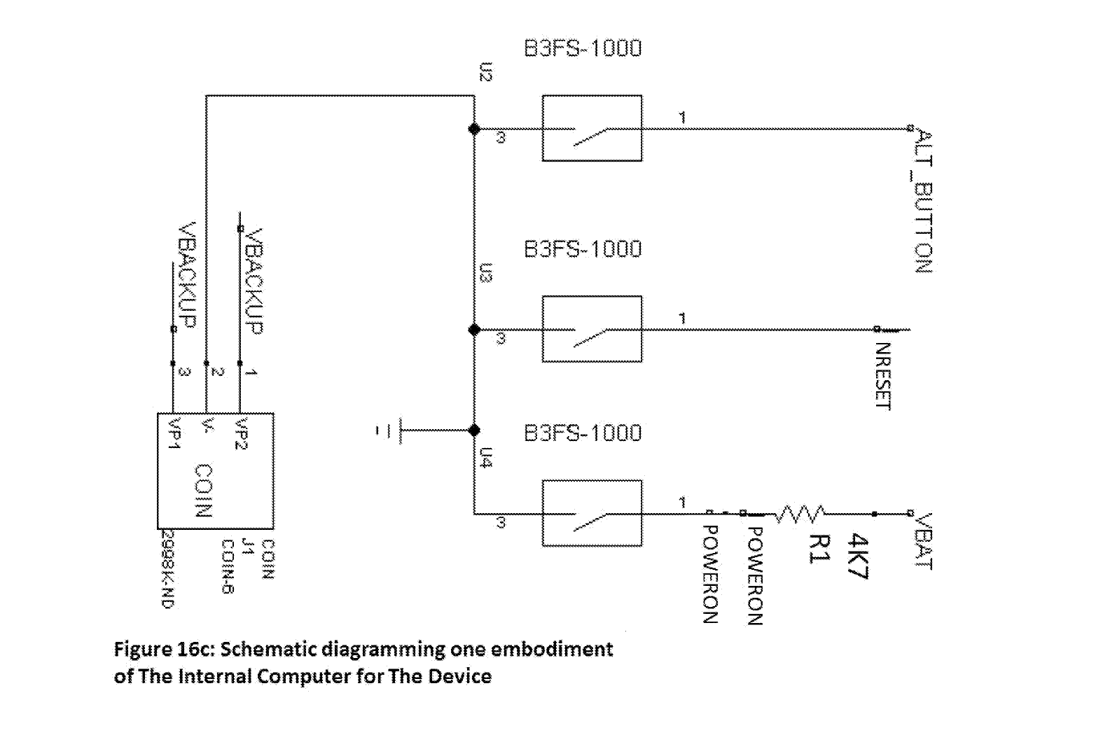

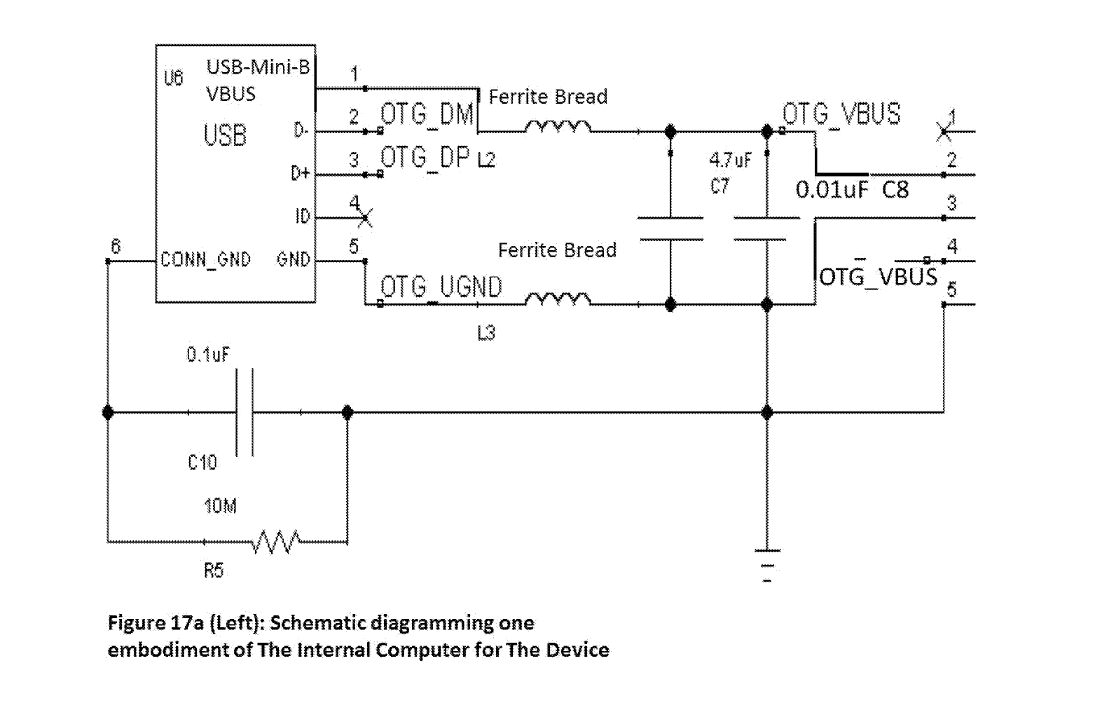

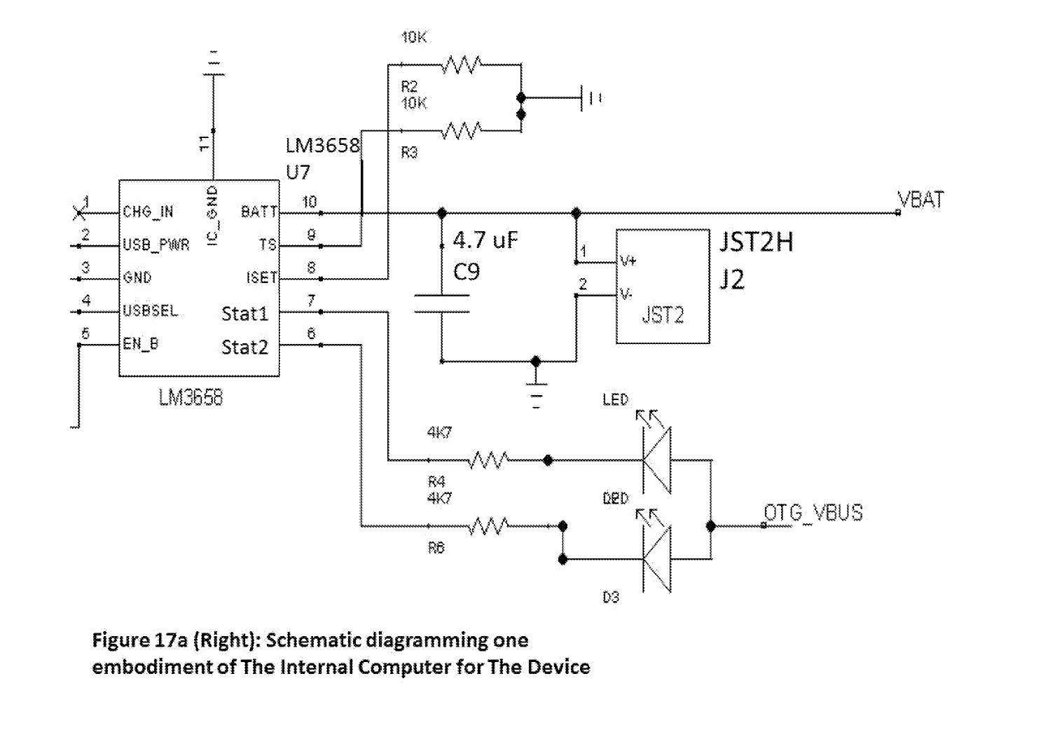

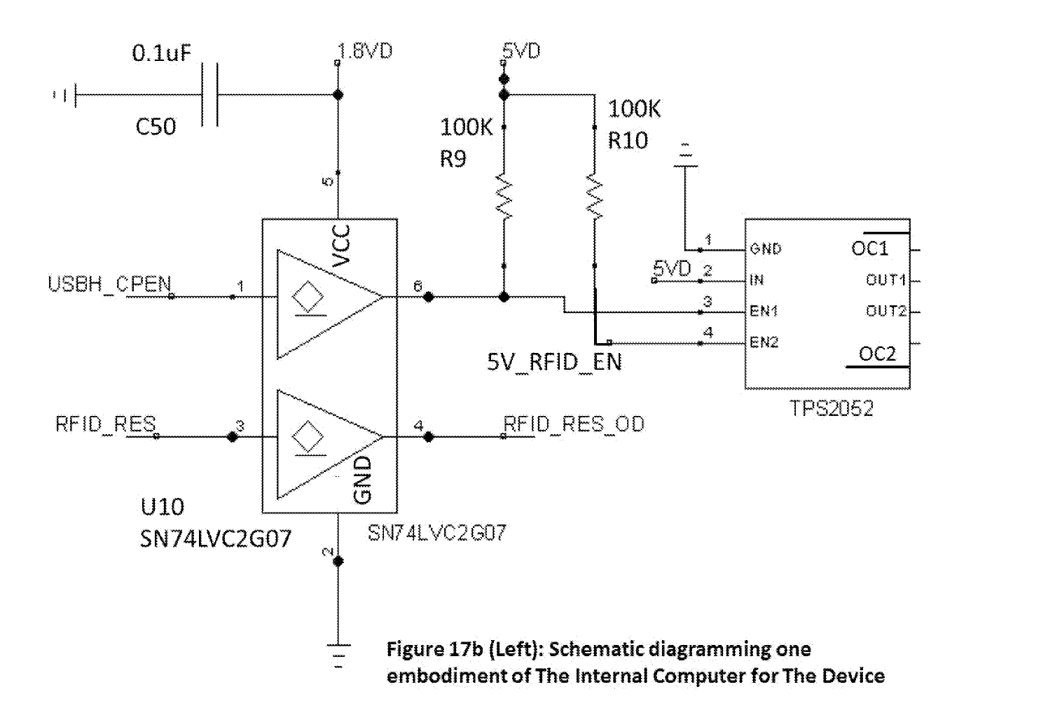

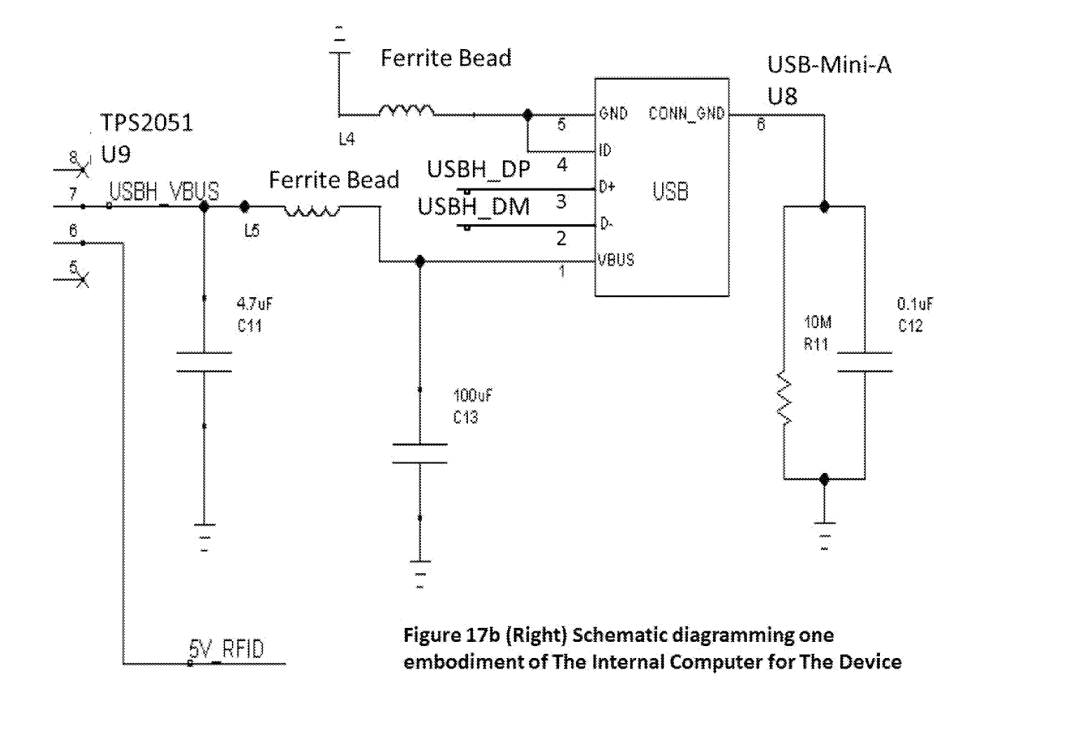

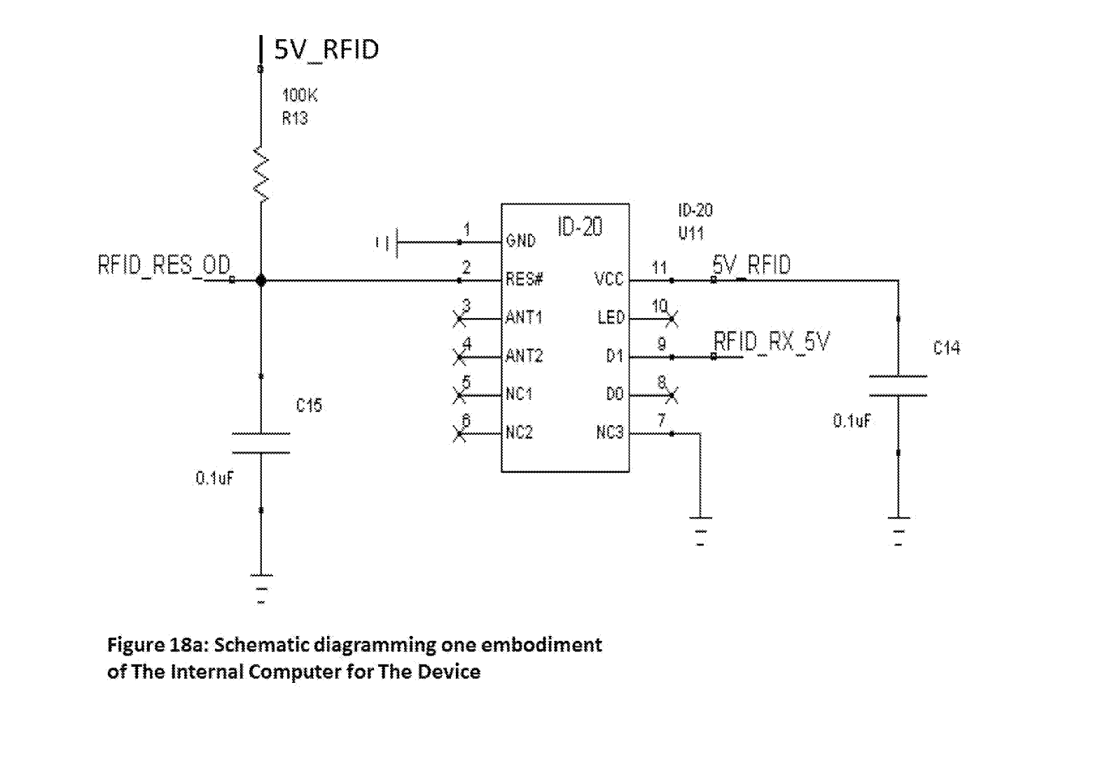

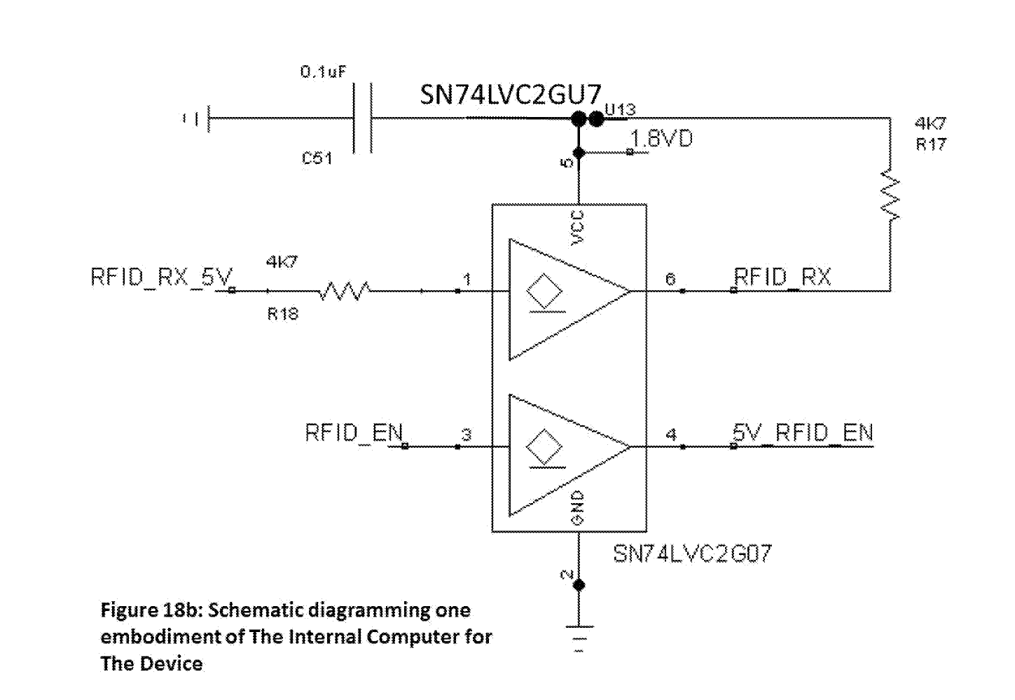

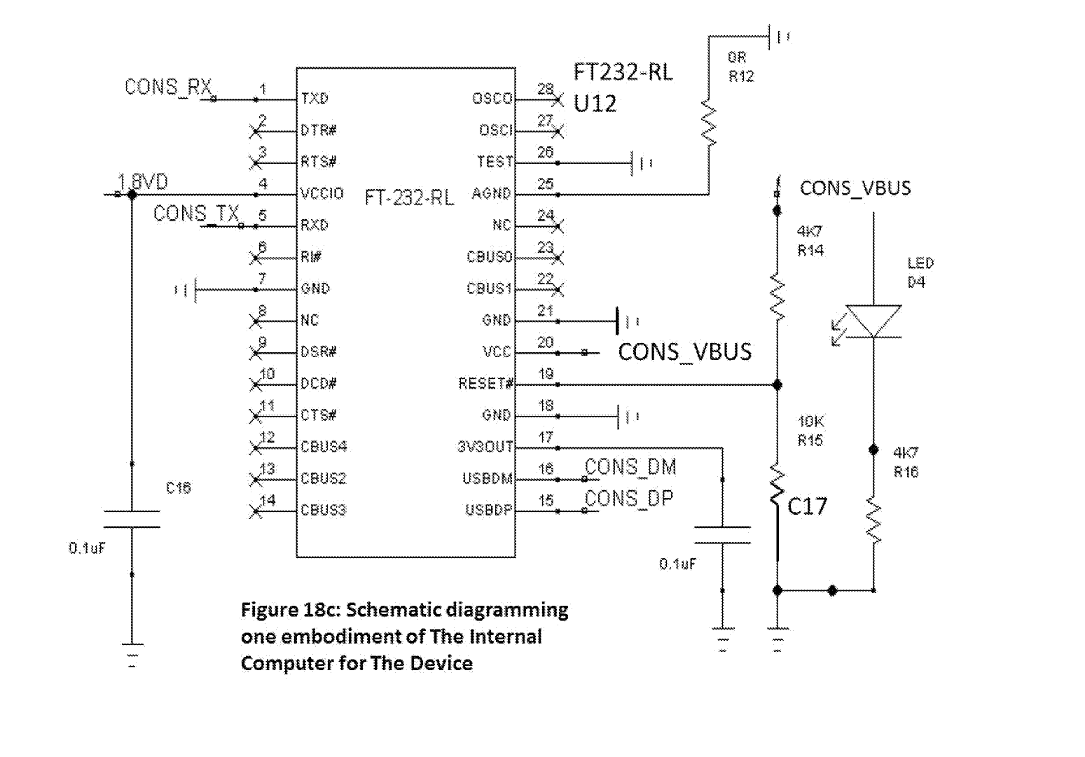

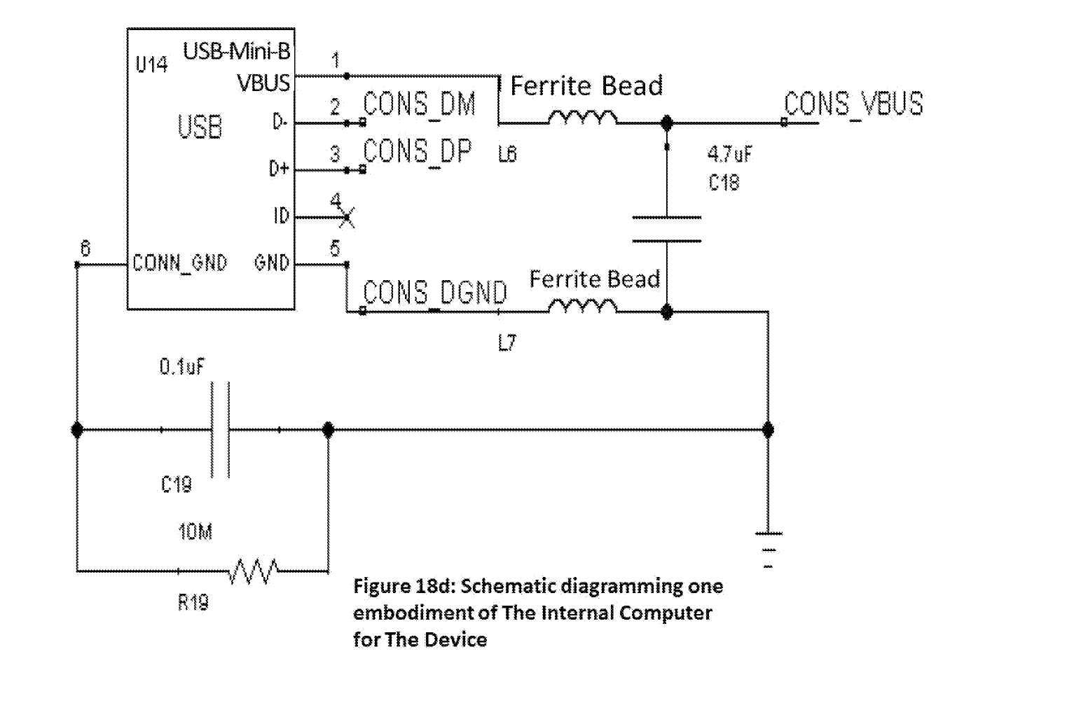

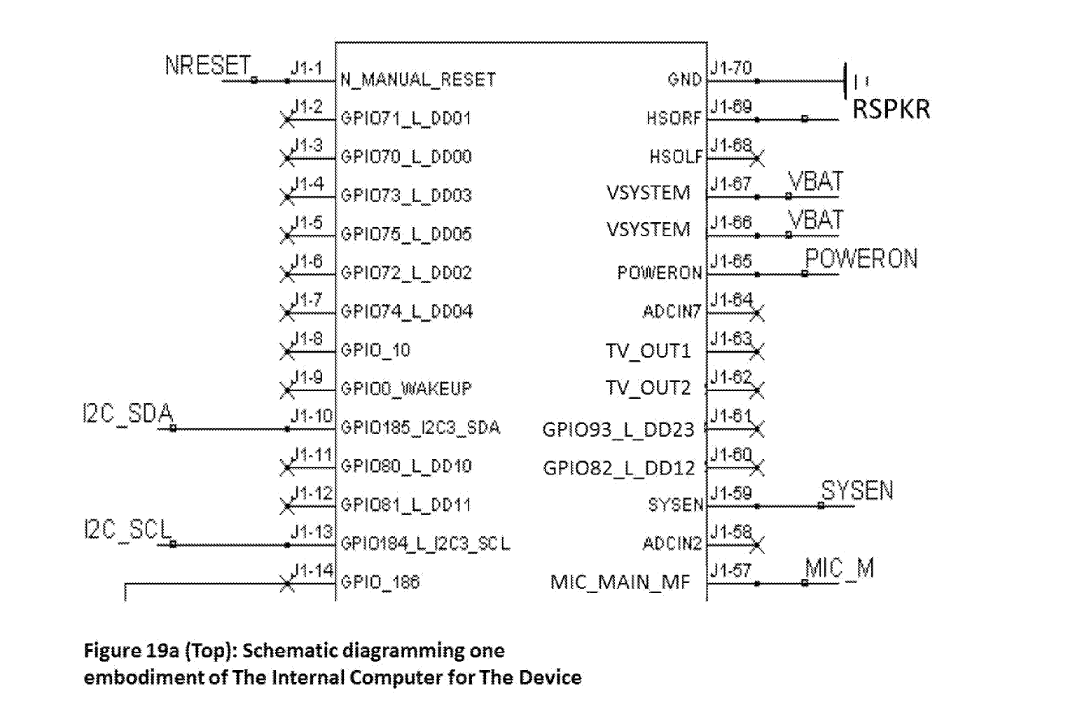

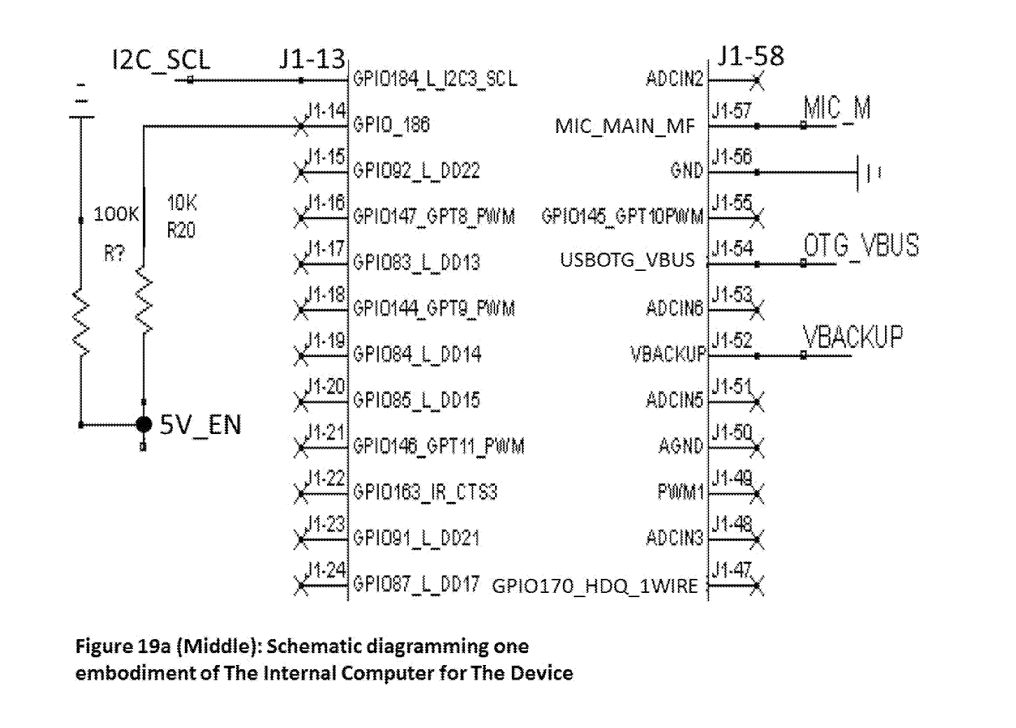

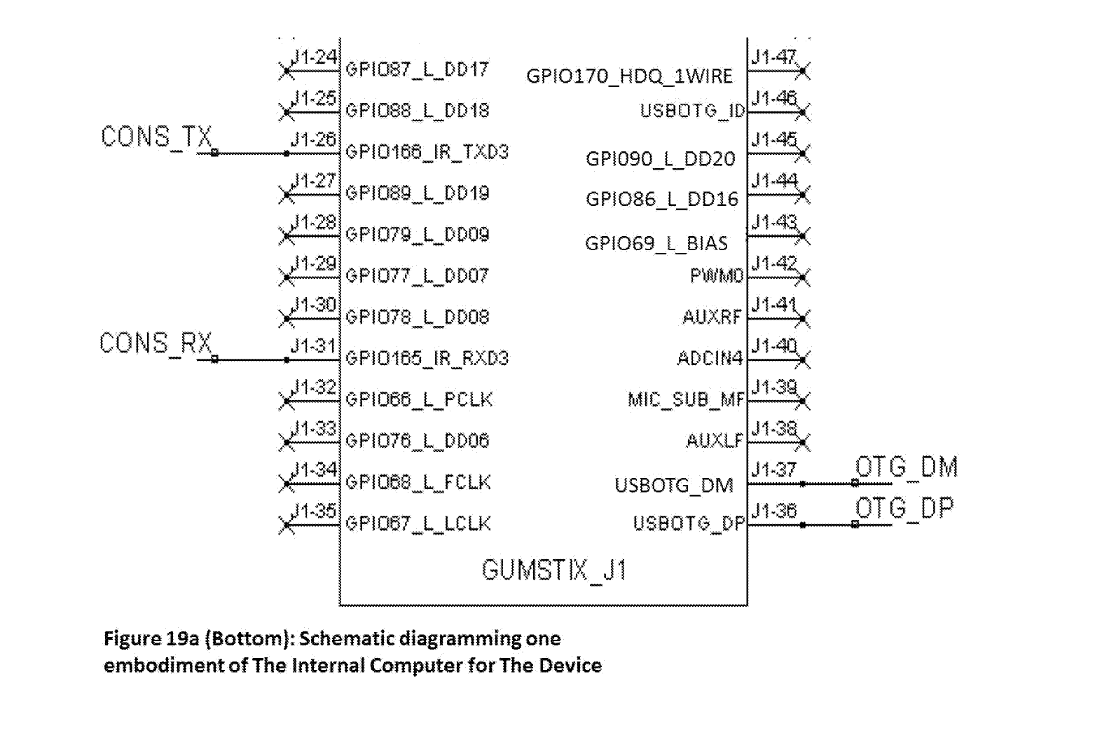

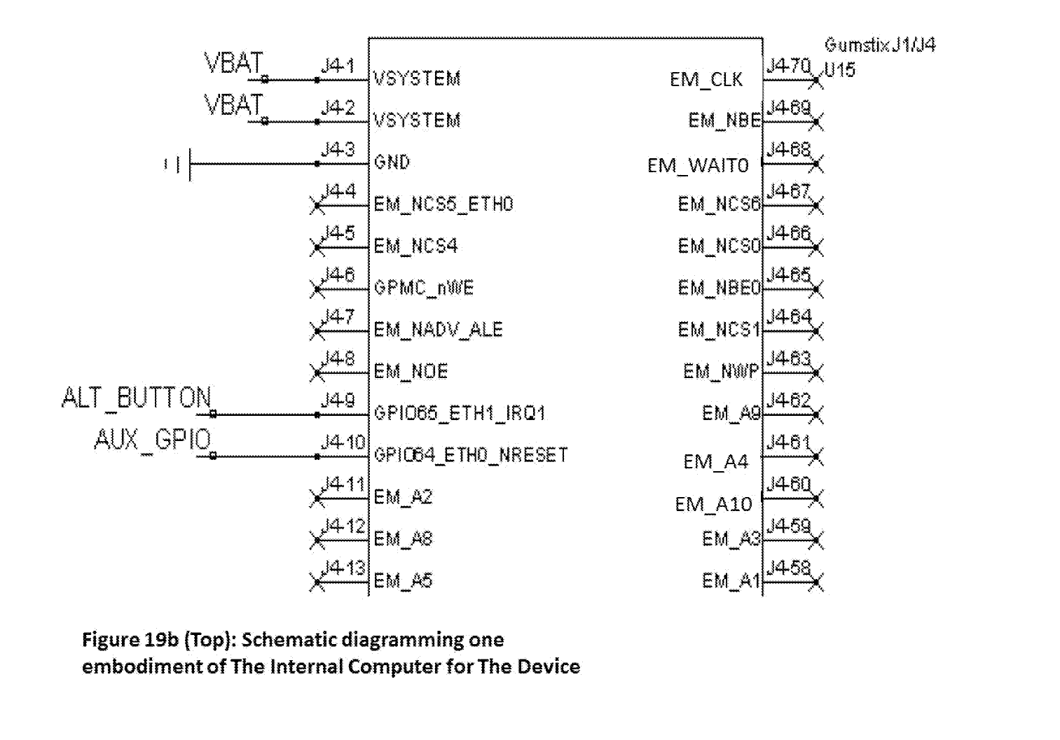

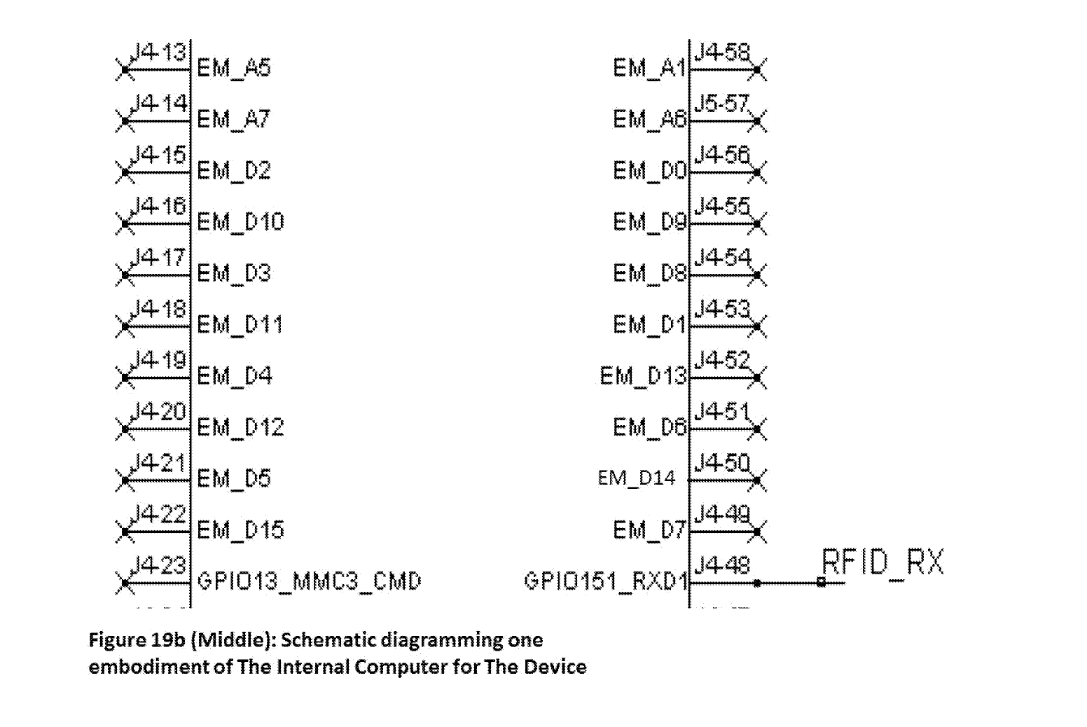

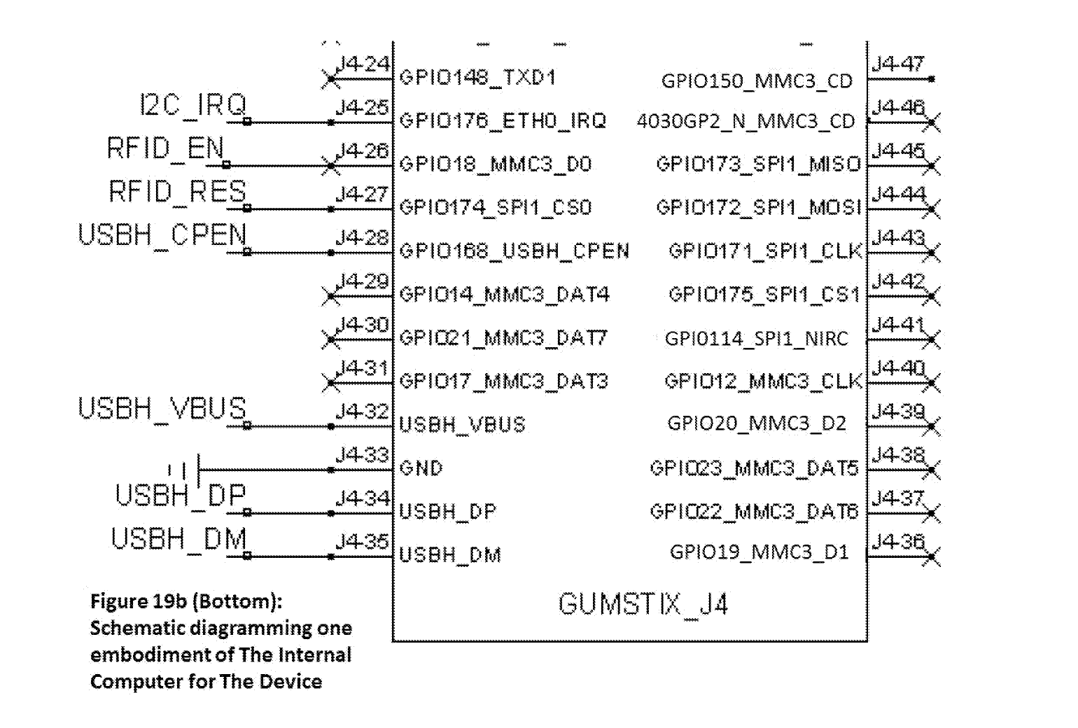

The internal computer 12 runs an operating system, such as the open source Android mobile operating system. Additionally, internal computer 12 may utilize a speech recognition platform as the main operating software, such as the open source PocketSphinx speech recognition platform. A diagram outlining how each of these components within the Device may be connected can be seen in FIGS. 13-19.

The Device 10 may be designed to greet the end user and await a command from the end user when the Device 10 is first powered on via a button press to determine what application logic the end user wishes to run. For example, if the end user wishes to play a nursery rhyme application, the end user may press and hold one of the control buttons on the device to launch the application logic corresponding to the nursery rhyme.

When using the Device Type 2 embodiment, the application selection may be determined by the specific smartphone or smart device's operating system. For example, if using an Apple iOS device, the application logic may be launched by clicking on one of the App icons from the home screen of the device.

Turning to FIG. 8, shown therein is one exemplary embodiment of a process 80 for launching application logic. By pressing the control button 1, the end user of the Device is able to cycle through the list of applications present inside the internal computer of the Device. When the control button is pressed and held, the selected application from the list is then launched by the Device 10.

Alternatively, if the end user wants to interact with the Device via a smart accessory, the Device may respond once that accessory is brought into proximity of its RFID reader.

Turning to FIG. 4, shown therein is an overview of an exemplary embodiment of a method 40 for how the Device resolves RFID tag IDs to smart accessory/card type. The Device contains an internal database, which resolves RFID tag IDs (e.g., 123ABC or XYZ987) to smart accessory 41 and smart card types 42 (e.g., baseball glove, Santa Claus, etc.).

In step 43, the Device reads the RFID tag present in a smart accessory or smart card. Next, in step 44, the Device checks to see if the RFID tag exists in its internal database. If the RFID exists in the internal database of the Device, the process moves to step 45, and if not, the process moves to step 46.

When the Device 10 reads an RFID tag ID, if an entry in the internal database exists for that ID, the Device is able to resolve the ID to the accessory type 42 in which case in step 45 the Device reacts appropriately for the smart accessory 41 or smart card type 42, depending on the application or application update currently installed and running on the Device 10.

For RFID tag IDs that do not exist within the internal device database, in step 46 the Device sends a query to the end user's computer, which queries the central web server, which resolves the RFID tag ID to an accessory type, and claims the accessory type for the Device if not already owned.

This query may be accomplished during the next synchronization with the end user's Computer. During this synchronization session, the Device passes the unknown RFID tag ID to the end user's computer 22, which queries the central web server 21 to resolve the RFID tag ID to smart accessory/card type. If a smart accessory/card exists for the RFID tag ID in the central web server 21, the end user's computer 22 passes this information back to the Device 10, and the Device 10 updates its internal database. If the smart accessory/card is not currently claimed by another Device, the Device 10 that first queries the central web server 21 with the unclaimed RFID tag ID lays claim to that smart accessory/card.

The application logic of the Device can be updated via a synchronization operation with the end user's computer. Turning to FIG. 2, shown therein is an overview in a block diagram format of how the Device 10 receives wireless updates and configuration from a central web server 21 during a synchronization operation.

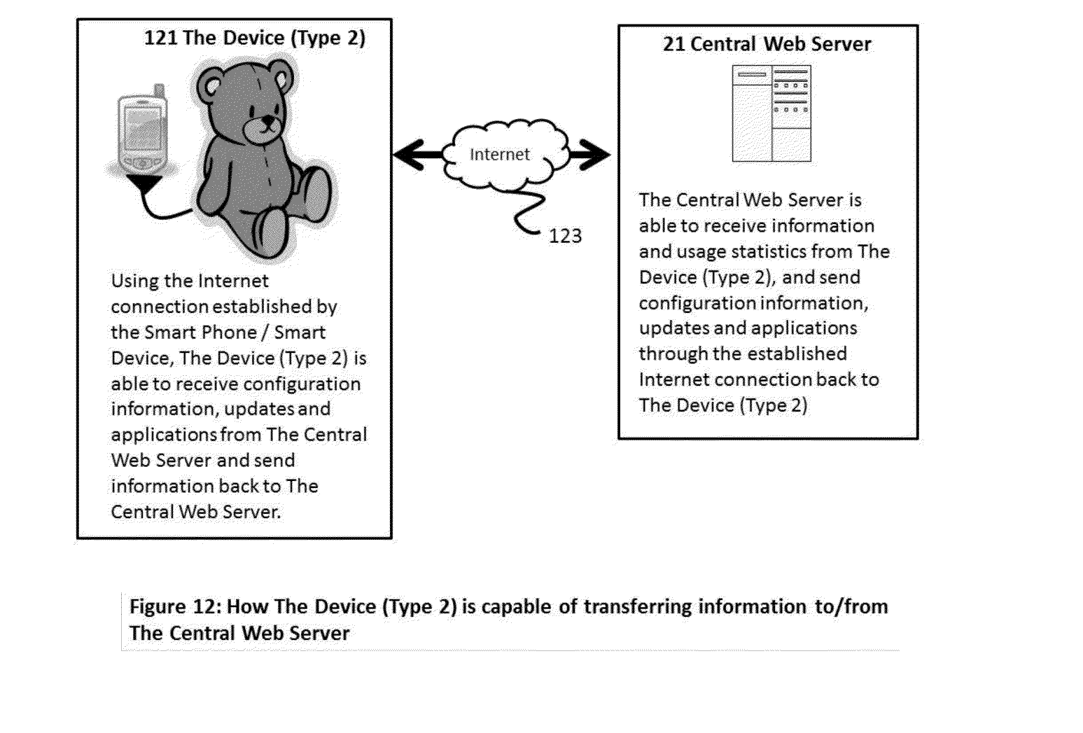

The central web server 21 stores applications, updates, configuration information, and statistics for each and every device, such as the Device 10. The central web server 21 sends/receives this information to/from an end user's computer 22 through an Internet connection 23. If the Device Type 2 has an on-board internet connection, the Device Type 2 will send/receive this information directly to/from the central web server 21 without requiring the end user's computer 22 as an intermediary (see FIG. 12).

Turning to FIG. 12, shown therein is a block diagram as to how the Device (Type 2) 121 is capable of transferring information to/from the central web server 21. Using the Internet connection 123 established by the smart phone/smart device, the Device (Type 2) 121 is able to receive configuration information, updates and applications from the central web server 21 and send information back to the central web server 21. The central web server is able to receive information and usage statistics from the Device (Type 2) 121, and send configuration information, updates and applications through the established Internet connection 123 back to the Device (Type 2) 121.

Returning to FIG. 2, an end user's computer 22 is able to communicate back and forth with the central web server 21 through an Internet connection 23, and communicate back and forth with the Device 11 through Bluetooth technology 24 provided by the dongle 17 in FIG. 1. This communication is achieved by a background software application running on the end user's computer 22.

The Device 10 is capable of communicating back and forth with an end user's computer 22 through Bluetooth technology 24, and through this communication able to receive the updates and configuration information passed from the central web server 21 to the end user's computer 22. Through this Bluetooth communication 24, the Device 10 is also able to send statistics back to the end user's computer 22, which passes them back to the central web server 21.

When the Device 10 is brought within proximity of the Bluetooth dongle 17, the Device 10 and the end user's computer 22 are capable of establishing a Bluetooth connection 24. The applications/updates and configuration information chosen for the Device 10 via the online store can be then automatically downloaded by a background software application running on the end user's computer 22. These applications/updates and configuration information can then be transferred to the Device 10 over a Bluetooth connection 24 and installed on the Device 10.

Turning to FIG. 10, shown therein is another exemplary embodiment of the Device 100. This embodiment 100 uses the smartphone' s CPU, memory, microphone, speaker, Bluetooth card and Internet connection. The user's smart phone or smart device 104 (e.g., iPhone®, Android® phone, Android® device, iPad®, iTouch®) plugs into a data/power cord 103 residing in an internal pouch inside the shell 102. The data/power cord 103 is connected to an RFID tag reader 116 (see FIG. 11, which shows the components residing inside the shell 102) and two control buttons (112, 113) residing in two different extremities of the shell 102. The Device (Type 2) 100 is capable of performing the same functionality outlined in FIGS. 3-4 and 6-8, leveraging the CPU, memory, battery, Bluetooth connectivity, WiFi, audio speaker, and audio microphone of the end user's smartphone/smart device. This functionality is achieved through the direct connection of the smartphone or smart device to the RFID tag reader via the data/power cord 103, which allows for interaction with smart accessories or pressed button commands from the end user. Since the software running on the Device (Type 2) 100 is capable of having identical functionality to the software running on the Device 10, the interactive experience provided to the end user is identical. For smart devices that have an active wireless data connection (e.g., via wireless internet access or via a cellular phone data connection), synchronization with the central web server may also be direct, and not mediated by the end user's computer, as explained in the sections below and shown in FIG. 12 and discussed above.

The end user's smart phone or smart device may include: (a) CPU; (b) memory; (c) a rechargeable battery; (d) a Bluetooth connectivity adapter; (f) an audio speaker; (g) an audio microphone; (h) a visual screen; (i) a data/power port; and (j) a WiFi or wireless data connection.

Shell 102 contains an internal pouch that's capable of containing the data/power cord and the end user's smartphone.

### Applications/Application Logic Updates

In one embodiment, the Device may be capable of running a number of Applications/Updates that provide different functionality. Using the online store outlined in FIG. 5, the End User has the ability to select or purchase different applications or updates that will be transferred onto their specific Device during a synchronization operation, as discussed with relation to FIGS. 2 and 12. These types of applications/updates may be, but are not limited to, stories (e.g., fairy tales, historical stories, fantasy stories), songs (e.g., historical songs, popular songs), dynamic stories (stories that change their endings depending on choices made by the end user mid-way through the story, by a verbal command, or smart accessory/card), educational games (e.g., foreign language learning games, math concept games), and device-to-device multiplayer games (e.g., battle games, puzzle games). After these applications/updates are transferred onto The Device during the synchronization process, the end user is able to select which application or update they wish to play by a process including but not limited to the process outlined in FIG. 8.

Turning to FIG. 5, shown therein is an exemplary process for choosing updates and configuration for the Device from the online store hosted on the central web server. From the end user's computer 22, the user is able to choose device updates and configuration options for the Device 10 from the web portal's online store 51. These device updates and configuration options are then automatically downloaded to the end user's computer 22 to be transferred onto the Device 10 by the background software application running on the end user's computer 22.

The end user is able to connect to the online store 51 hosted by the central web server 21 to purchase and download updates for the Device 10. The end user is also able to configure the Device 10 from this online store 51. Updates and configuration information are automatically downloaded by the end user's computer 22 and pushed to the Device 10 via the background software application running on the end user's computer 22.

As evident in FIG. 5, the end user can select options to be downloaded, enter billing address or shipping address information, such as zip code and name. The types of updates being purchased or which have been purchased can be shown as well.

### The Bluetooth Dongle

In one embodiment, the system 10 may also contain a Bluetooth adapter dongle 17 as shown in FIG. 1. This dongle 17 is able to plug into a port (including but not limited to USB and FireWire) of the end user's computer 22 and enables a Bluetooth connection (such as Bluetooth connection 24) to be established between the end user's computer 22 and the Device 10. It is over this Bluetooth connection 24 that the Device 10 can transfer information back and forth between the end user's computer 22 and the Device 10. The Bluetooth dongle 17 and the Device 10 may have a pre-established security pairing to allow for secure communication between the two entities.

### The End User's Computer

In one embodiment, the end user's computer 22 is also part of the system. The end user's computer 22 may communicate with the central web server 21 and/or the Device 10 during a synchronization process. The end user is also able to access the online store 51 (hosted on the central web server 21) through their internet connection 23 and a web browser (not shown).

A synchronization operation may also be initialized by the Device 10 when brought within the transmission range of the Bluetooth dongle 17, which is attached to the end user's computer 22 in one embodiment. When the synchronization initiates, the Device 10 may send application statistics over the Bluetooth connection 24 to the end user's computer 22, and a background service software application running on the end user's computer 22 is capable of uploading these statistics to the central web server database (not shown) available via server 21. The background service application running on the end user's computer 22 is also capable of downloading the desired applications/updates that were selected for download from the online store 51 residing on the central web server 21. After the background service on the end user's computer downloads the desired applications/updates/configuration information, the desired applications/updates/configuration information are able to be pushed over the wireless Bluetooth connection 24 onto the Device 10, as shown in FIG. 2.

### The Central Web Server

In one embodiment, the central web server 21 may have responsibilities that include: hosting the online store 51, transferring information back and forth from the end user's computer 22 or transferring information back and forth from the Device Type 2 as shown in FIG. 12.

The online store 51 may be a website where the end user, or someone acting on the behalf of the end user, is able to choose applications/updates for their individual Device 10 and choose configuration options for their Device 10. End users may create an account to manage their device and log in to the online store 51 to begin choosing applications and configuration options for their Device 10. The user may then save their updates, which may be recorded in a database residing within the central web server 21.

The central web server is also responsible for handling the transfer of applications/updates and configuration information explained in previous sections and outlined in FIGS. 2 and 12.

The central web server 21 may also contain a database (not shown) with the exhaustive mapping between smart accessory/card type and the individual RFID tag contained within the smart accessory/card. Within this database, each individual smart accessory/card can be linked to an individual Device, thereby “claiming” the smart accessory/card for that particular Device 10. During a synchronization operation, these mappings between RFID tag ID and smart accessory/card type may be transferred onto the Device 10 for use by an application or update running on the Device 10.

### Smart Accessories and Smart Cards

In one embodiment, the educational and entertaining experience provided by the Device may be enhanced through its ability to interact with smart accessories and smart cards. Contained within the internal computer of the device may be an RFID reader chip capable of reading unique RFID tags within proximity of several inches.

Turning to FIG. 3, shown therein is an overview of how the Device interacts with smart accessories and smart cards. The Device 10 contains a RFID (Radio-Frequency Identification) tag reader capable of uniquely recognizing RFID tags when brought within proximity of the device. The RFID read range 33 is several inches. When the RFID reader detects an RFID tag inside a smart accessory 31 or smart card 32, the Device 10 changes its behavior depending on which unique smart accessory 31 or card 32 was detected and the application or application update currently being run on the Device 10.

As part of the learning device system, a suite of smart accessories and smart cards (wherein each may contain a unique RFID tag) may be available for interaction with the device as shown in FIGS. 3 and 11. When a smart accessory or smart card is brought within proximity of the RFID reader contained in the internal computer of the device, the Device may be capable of changing its behavior depending on the unique ID of the passive RFID tag inside the smart accessory or smart card which is achieved by the current application or application update currently installed and running on the Device, as shown in FIG. 4. For example, if The Device was currently running a Spanish language application, bringing a smart accessory resembling a baseball glove within proximity of the device may have the device recite the Spanish word for baseball glove.

Referring to FIG. 3, smart accessories 31 contain an RFID tag that is recognized by the Device when brought within proximity of the device's internal RFID reader. Depending on the type of smart accessory (determined by the unique ID of the RFID tag) the Device will change its behavior.

The application or application logic (app) that is running on the device governs the current behavior of the device at that time and how it interacts with smart accessories and smart cards. For example, in a game that requires the end user to ‘feed’ the device a ‘juice bottle’ smart accessory, the application may keep track of the number of times that the end user presents this accessory to the device, the time interval between accessory presentations, and the duration of each presentation to the device. In the previous example, the device may issue different responses if the ‘juice bottle’ accessory is given too frequently (e.g. “you're feeding me too much, I'm not thirsty”), not frequently enough (e.g. “I'm thirsty, can I have some juice?”), or not a long enough duration each time (e.g. “You pulled the juice bottle away from me too quickly”).

The Device includes the capability to detect for how long a smart accessory/card has been in range. For example, the RFID reader passes along real-time information about when a tag enters the range of the RFID reader (i.e., the read proximity) and leaves read proximity, allowing the Device to determine the length of time that the RFID tag in question remained within proximity of the Device. This enables more robust interactivity with the learning device or toy.

Smart accessories 31 may consist of an exterior “shell” that resembles a physical object (e.g., Baseball glove, Skateboard, etc.). The “shell” of the object may either be plush fabric, plastic, or wood. Contained within the shell of the object may be a miniature RFID tag capable of being read by the RFID reader inside the device. Depending on the appearance of the smart accessory, its effect on the logic of the device may be different which is achieved by the current application or application update currently installed and running on the Device. For example, a “Santa Claus” hat smart accessory may be programmed to run application logic that sings Christmas carols to the end user.

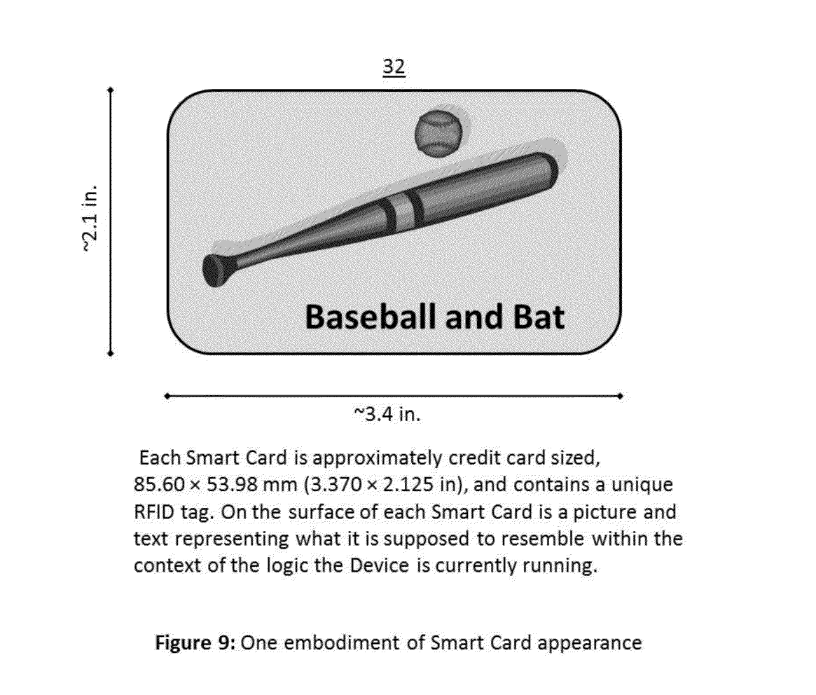

Referring to FIG. 3, smart cards 32 may have similar functionality to smart accessories 31. Each smart card 32 may be a standard size, approximately the size of a credit card, as shown in FIG. 9.

Turning to FIG. 9, each smart card 32 is approximately credit card sized, 85.60×53.98 mm (3.370×2.125 in), and contains a unique RFID tag (not shown). On the surface of each smart card 32 is a picture and text representing what it is supposed to resemble within the context of the logic the Device is currently running.

Each smart card 32 contains a unique RFID tag inside that is able to be read by the RFID reader contained within the device. Since the RFID tag in this smart card 32 is different than the RFID tag in the smart accessory 31 pictured above, the Device will act differently when it recognizes this smart card.

In one embodiment, the Device maintains an internal database that keeps track of the resolution between RFID tag IDs and smart accessory/card types. For example, a smart accessory that resembles a baseball glove might contain an RFID Tag with ID of “123ABC”. The Device's internal database may be capable of tracking the association between RFID Tag “123ABC” and smart accessory type “baseball glove”. For RFID tag IDs that do not currently reside in the internal device database, the Device may be capable of issuing a query to the central web server to resolve this RFID tag ID to smart accessory/card type mapping. During the next synchronization, the Device may pass the unknown RFID tag IDs to the end user's computer, which queries the central web server to see if a mapping exists between the unknown RFID Tag ID and the smart accessory/card type (the central web server maintains the exhaustive list of these mappings). If a mapping exists on the central web server, the end user's computer may pass this information back to the Device, which updates its internal database with the new RFID tag ID to smart accessory/card type.

If the smart accessory is not currently claimed by an existing Device, the first Device to issue a query to the central web server for an unclaimed RFID tag ID may lay claim to that particular RFID tag ID (and associated smart accessory/card). Smart accessory claims may be used by some device applications to ensure that only one device is capable of using a smart accessory/card simultaneously.

### Speech Recognition

Turning to FIG. 6, shown therein is an overview of a method 60 for how the Device interacts through speech recognition. The computer 12 inside the Device 10 is equipped with a microphone and software capable of translating human speech into text using a software package installed on the Device 10. Depending on speech keywords picked up by the microphone inside the Device, the Device may react differently or give a different audio reply to the device user.

The end user will be prompted by the Device when it is listening for speech commands. Depending on the speech command issued by the end user, the Device may behave differently or give a different audio reply to the device user.

In step 61, the Device 10 indicates to the end user that it's listening for speech commands. This indication may be in the form of a tone or voice message. In step 62, the end user issues a speech command to the Device 10. In step 63, the Device resolves which voice command (A or B) was issued. While only two are shown, many more are possible. If command A is issued, in step 64 the Device reacts appropriately for Command A, depending on the application or application update running on the Device 10. If Command B is resolved, the Device 10 reacts appropriately for Command B, depending on the application or application update running on the Device 10.

### Communication

Turning to FIG. 7, shown therein is an overview of how the device-to-device communication works. Each device 71 is capable of communicating with other like devices 72 over a Bluetooth connection. When a specific button combination on each device 71 is pressed, a search is conducted to see if there are any additional devices 72 within range of the Bluetooth card inside the device 71. If another device 72 is found (e.g. Device B 72), Device A 71 establishes a connection to Device B 72 and passes information back and forth between the devices 71, 72.

When a specific button combination is pressed on each device, Device A 71 and Device B 72 establish a connection and pass information back and forth. In method 70, the process begins with step 73 in which a specific button combination on both devices 71, 72 is pressed.

In step 74, a search for in-range like-devices over a Bluetooth connection is initiated. In step 75, Device A 71 finds Device B 72 over a Bluetooth connection. In step 76, Device A 71 and Device B 72 exchange information over a Bluetooth connection.

### Computer Readable Media

The present invention also includes a non-transitory computer readable media having stored thereon an end user application, which when executing enables an end user computer to perform a synchronization process with the internal computer and to obtain configuration updates and new applications from a central web server. This application enables the end user computer to perform all of the functions described above. This non-transitory computer readable media may include a DVD or compact disk that can be loaded into a traditional computer. Also, the computer readable media may include a file that can be downloaded from the internet or other network.

Additionally, for the Device Type 2, a computer program or application may be downloaded to the portable computer or smart phone, which then enables the smart phone to act as the Device, thereby enabling the toy to leverage the power and capability of one's smart phone or portable computer.

What is claimed is:

1. An interactive entertainment apparatus comprising:
a) an exterior shell having a humanoid or animal shape, said shape including one or more extremities, said shell housing:
(i) an internal computer, said internal computer including:
(1) a central processing unit;
(2) memory coupled to the central processing unit;
(3) a rechargeable battery to power the internal computer;
(4) a wireless connectivity adapter coupled to the central processing unit to provide wireless connectivity to one or more other wireless devices when brought in a predetermined proximity of the shell;
(5) a radio frequency identification tag reader to read a radio frequency identification tag when brought in a vicinity of the shell, wherein said internal computer executes a predetermined application associated with an identified radio frequency identification tag to change behavior of the shell upon detection and identification of a new radio frequency identification tag, and said internal computer determines when a given radio frequency identification tag entered a proximity of the shell and when the given radio frequency identification tag left the proximity of the shell to determine how long the radio frequency identification tag remained in the proximity of the shell, and said internal computer determines how long the given radio frequency identification tag has remained in proximity of the shell for use in controlling behavior of the shell;
(6) a wireless network adapter; and
(7) an internal database to store information regarding a plurality of smart cards and a plurality of smart accessories, each of said plurality of smart accessories having associated with it a unique smart accessory radio frequency identification tag and each of said plurality of smart cards having associated with it a unique smart card radio frequency identification tag, wherein said internal database stores a plurality of smart card applications in association with a plurality of smart cards, one smart card application for each of the plurality of smart cards, said internal database stores a plurality of smart accessory applications in association with a plurality of smart accessories, one smart accessory application for each of the plurality of smart accessories, wherein each of said plurality of smart accessory applications controls behavior of the shell in response to said shell being brought in proximity to an associated smart accessory, and each of said plurality of smart card applications controls behavior of the shell in response to said shell being brought in proximity to an associated smart card; and
(ii) one or more tactile control buttons coupled to the internal computer, said one or more tactile control buttons being activated by pressing, wherein a user may select one or more applications to execute on the internal computer by pressing one of the one or more tactile control buttons and cycling through the one or more applications each time the one or more tactile control buttons is pressed, and then holding said one of the one or more tactile control buttons for a predetermined time to select the desired one of the one or more applications; and
b) a non-transitory computer readable media having stored thereon an end user application, which when executing enables an end user computer to perform a synchronization process with the internal computer and to obtain configuration updates and new applications from a central web server;
said internal computer to communicate with an end user computer via the wireless connectivity adapter to obtain configuration updates and new applications during an synchronization process with the end user computer; and
said internal computer to communicate with a central web server via the wireless network adapter.

2. The interactive entertainment apparatus according to claim 1, wherein the internal computer further comprises:
an audio speaker to output audio signals from the central processing unit.

3. The interactive entertainment apparatus according to claim 1, wherein the internal computer further comprises:
an audio microphone to pick up audio signals and provide these audio signals to the central processing unit.

4. The interactive entertainment apparatus according to claim 3, wherein the internal computer further comprises speech recognition capability to respond to one or more voice commands issued by a user, wherein said internal computer executes a predetermined application based on a recognized one of a plurality of voice commands.

5. An updatable, interactive entertainment apparatus comprising:
a) an exterior shell having a humanoid or animal shape, said shape including one or more extremities, said shell having a data/power cord to couple to a portable computing device:
b) one or more tactile control buttons to couple to the smart phone via the data/power cord, said one or more tactile control buttons being activated by pressing, wherein a user may select one or more applications to execute on the smart phone by pressing one of the one or more tactile control buttons and cycling through the one or more applications each time the one or more tactile control buttons is pressed, and then holding said one of the one or more tactile control buttons for a predetermined time to select the desired one of the one or more applications; and
c) a non-transitory computer readable media having stored thereon an application for execution on the portable computing device, which application when executing enables the portable computing device to:
(i) provide wireless connectivity to one or more other wireless devices when brought in a predetermined proximity of the shell;
(ii) provide a radio frequency identification tag reader to read a radio frequency identification tag when brought in a vicinity of the shell, wherein said application enables said portable computing device to execute a predetermined application associated with an identified radio frequency identification tag to change behavior of the shell upon detection and identification of a new radio frequency identification tag, and said application enables said portable computing device to determine when a given radio frequency identification tag entered a proximity of the shell and when the given radio frequency identification tag left the proximity of the shell to determine how long the radio frequency identification tag remained in the proximity of the shell to enable the portable computing device to use this length of time to control behavior of the shell;
(iii) store an internal database of information regarding a plurality of smart cards and a plurality of smart accessories, each of said plurality of smart accessories having associated with it a unique smart accessory radio frequency identification tag and each of said plurality of smart cards having associated with it a unique smart card radio frequency identification tag, wherein said internal database stores a plurality of smart card applications in association with a plurality of smart cards, one smart card application for each of the plurality of smart cards, said internal database stores a plurality of smart accessory applications in association with a plurality of smart accessories, one smart accessory application for each of the plurality of smart accessories, wherein each of said plurality of smart accessory applications controls a behavior of the shell in response to said shell being brought in proximity to an associated smart accessory, and each of said plurality of smart card applications controls a behavior of the shell in response to said shell being brought in proximity to an associated smart card;
(iv) enable an end user computer to perform a synchronization process with the portable computing device and to obtain configuration updates and new applications from a central web server; and
(v) enable the portable computing device to communicate with a central web server.

6. The interactive entertainment apparatus according to claim 5, wherein the application enables the portable computing device to recognize one or more voice commands issued by a user, wherein said application enables the portable computing device to execute a predetermined application based on a recognized one of a plurality of voice commands to cause the shell to behave in a way responsive to the voice command.

7. The updatable, interactive entertainment apparatus according to claim 5, wherein the portable computing device comprises a smart phone.

8. The updatable, interactive entertainment apparatus according to claim 5, wherein the portable computing device comprises a handheld computer.

9. The updatable, interactive entertainment apparatus according to claim 5, wherein the portable computing device comprises a laptop computer.

10. A non-transitory computer readable media having stored thereon an application for execution on a portable computer to control an entertainment device, which application when executing causes the portable computer to:
a) connect wirelessly to one or more other wireless devices when brought in a predetermined proximity of the entertainment device;
b) read a radio frequency identification tag when brought in vicinity of the shell;
c) execute a predetermined application associated with an identified radio frequency identification tag to change behavior of the shell upon detection and identification of a new radio frequency identification tag;
d) determine a length of time a given radio frequency identification tag remained in proximity of the shell to use the length of time to control behavior of the shell; and
e) store an internal database of information regarding a plurality of smart cards and a plurality of smart accessories, each of said plurality of smart accessories having associated with it a unique smart accessory radio frequency identification tag and each of said plurality of smart cards having associated with it a unique smart card radio frequency identification tag, wherein said internal database stores a plurality of smart card applications in association with a plurality of smart cards, one smart card application for each of the plurality of smart cards, said internal database stores a plurality of smart accessory applications in association with a plurality of smart accessories, one smart accessory application for each of the plurality of smart accessories, wherein each of said plurality of smart accessory applications controls a behavior of the shell in response to said shell being brought in proximity to an associated smart accessory, and each of said plurality of smart card applications controls behavior of the shell in response to said shell being brought in proximity to an associated smart card.

11. The non-transitory computer readable media according to claim 10, wherein said application obtains configuration updates and new applications for the entertainment device from a central web server.

12. The non-transitory computer readable media according to claim 10, wherein said application enables the portable computer to communicate with a central web server to obtain configuration information, updates or new applications for the entertainment device.

13. A method for enabling a learning device or toy to interact with an end user comprising:
a) disposing an internal computer inside an exterior shell of the learning device or toy;
b) providing a wireless connectivity to one or more other wireless devices when brought in a predetermined proximity of the learning device or toy;
c) reading a radio frequency identification tag when brought in a vicinity of the learning device or toy; and
d) executing a predetermined application associated with an identified radio frequency identification tag to change behavior of the learning device or toy upon detection and identification of a new radio frequency identification tag.

14. The method according to claim 13, further comprising:
determining how long a radio frequency identification tag remained in proximity of the learning device or toy; and
controlling behavior of the learning device or toy based on a length of time the given radio frequency identification tag remained in proximity of the learning device or toy.

15. The method according to claim 13, further comprising:
storing inside the learning device or toy an internal database of information regarding a plurality of smart cards;
associating with each of said plurality of smart cards a unique smart card radio frequency identification tag;
storing in said internal database a plurality of smart card applications in association with a plurality of smart cards, one smart card application for each of the plurality of smart cards; and
controlling behavior of the learning device or toy with each of said plurality of smart card applications when the learning device or toy is brought in proximity of an associated smart card.

16. The method according to claim 13, further comprising:
storing inside the learning device or toy an internal database of information regarding a plurality of smart accessories;
associating with each of said plurality of smart accessories a unique smart accessory radio frequency identification tag;
storing in said internal database a plurality of smart accessory applications in association with a plurality of smart accessories, one smart accessory application for each of the plurality of smart accessories; and
controlling behavior of the learning device or toy with each of said plurality of smart accessory applications when the learning device or toy is brought in proximity of an associated smart accessory.

17. The method according to claim 13, further comprising:
providing one or more tactile control buttons coupled to the internal computer;
enabling a user to select one or more applications to execute on the internal computer by pressing one of the one or more tactile control buttons and cycling through the one or more applications each time the one or more tactile control buttons is pressed, and then holding said one of the one or more tactile control buttons for a predetermined time to select the desired one of the one or more applications.

18. The method according to claim 13, further comprising:
synchronizing the internal computer in the learning device or toy with an end user computer to obtain configuration updates and new applications from a central web server via the end user computer.

19. The method according to claim 13, further comprising:
receiving audio signals and providing the received audio signals to the internal computer.

20. The method according to claim 13, further comprising:
responding to one or more voice commands issued by a user by executing a predetermined application on the internal computer based on a recognized one of a plurality of voice commands.
